(19) United States
(12) Patent Application Publication
(10) Pub. No.: US 2026/0087538 A1
(43) Pub. Date: Mar. 26, 2026

(54) STORE DERIVATION DEVICE

(71) Applicant: NTT DOCOMO, INC., Tokyo (JP)

(72) Inventors: Yukiko YOSHIKAWA, Chiyoda-ku (JP); Tetsuya YAMAGUCHI, Chiyoda-ku (JP)

(73) Assignee: NTT DOCOMO, INC., Tokyo (JP)

(21) Appl. No.: 19/108,986

(22) PCT Filed: Sep. 7, 2023
(86) PCT No.: PCT/JP2023/032726

§ 371 Date: Mar. 5, 2025

(30) Foreign Application Priority Data
Nov. 15, 2022 (JP) 2022-182423

(51) Int. Cl. G06Q 30/0601

(52) U.S. Cl. CPC G06Q 30/06313

(57) ABSTRACT

An object is to provide a store derivation device that derives an appropriate recommendation target to enable efficient recommendation. A recommendation system 100 that functions as a store derivation device of the present disclosure includes a visit history storage unit 106 configured to store visit history information of a store as an action history of a user. Further, a store acquisition unit 101 acquires a familiar store (degree of familiarity) of the user with respect to the store on the basis of the visit history information. The store acquisition unit 101 derives a visit candidate store fx1 that the user is recommended to visit, on the basis of the familiar store (degree of familiarity).

### TECHNICAL FIELD

The present invention relates to a store derivation device that derives a store to be recommended to a user.

### BACKGROUND ART

Patent Literature 1 describes that, when a user searches for a store on the Internet, a recommended store is recommended to a user as information with a high degree of satisfaction according to a user's desire by a simple operation.

### CITATION LIST

### Patent Literature

[Patent Literature 1] Japanese Unexamined Patent Publication No. 2016-62401

### SUMMARY OF INVENTION

### Technical Problem

In performing recommendation for a customer referral to a store, it may not be possible to perform a customer referral using a degree of familiarity with the store such as whether the user is already familiar with, is interested in, or becomes a regular customer of the store, resulting in unnecessary recommendations.

Accordingly, to solve the above-described problem, an object of the present invention is to provide a store derivation device that derives an appropriate recommendation target to enable efficient recommendation.

### Solution to Problem

A store derivation device of the present invention includes a visit history storage unit configured to store an action history of a user, a calculation unit configured to calculate a degree of familiarity of the user with a store on the basis of the action history, and a store derivation unit configured to derive a candidate store that the user is recommended to visit, on the basis of the degree of familiarity.

### Advantageous Effects of Invention

According to the present invention, it is possible to derive a store that becomes a target of an appropriate recommendation.

### BRIEF DESCRIPTION OF DRAWINGS

FIG. 1 is a diagram illustrating an overview of the operation of a recommendation system 100 in the present disclosure.

FIG. 2 is a schematic view illustrating the concept of a recommendation effect.

FIG. 3 is a block diagram illustrating a functional configuration of the recommendation system 100 in the present disclosure.

FIG. 4 is a diagram illustrating a specific example of store information.

FIG. 5 is a diagram illustrating visit history information of each user.

FIG. 6 is a diagram illustrating a specific example of user attribute information.

FIG. 7 is a diagram illustrating a specific example of recommendation history information.

FIG. 8 is a flowchart illustrating acquisition of visit candidate stores in the recommendation system 100.

FIG. 9 is a flowchart illustrating detailed processing of recommendation evaluation in the recommendation system 100.

FIG. 10 is a diagram illustrating storage transition of visit history information.

FIG. 11 is a schematic view illustrating processing of acquiring a target visit candidate store fx1 by the store acquisition unit 101.

FIG. 12 is a diagram illustrating a nearby store near a target store.

FIG. 13 is a schematic view illustrating when a value of a visit candidate store is obtained from a generated visit history table.

FIG. 14 is a diagram illustrating a way of obtaining an attribute evaluation fx2_1.

FIG. 15 is a schematic view of a calculation method of a constraint evaluation fx2_2.

FIG. 16 is a block diagram illustrating a functional configuration of a learning device 120 that learns a situation model 108.

FIG. 17 is a diagram illustrating processing for preparation to generate the situation model 108.

FIG. 18 is a diagram illustrating a specific example of learning processing of the situation model 108.

FIG. 19 is a block diagram illustrating a functional configuration of a learning device 130 that learns an estimation model 109 for obtaining an irrationality evaluation fx3.

FIG. 20 is a schematic view illustrating generation of various management tables.

FIG. 21 is a diagram illustrating learning processing using various management tables.

FIG. 22 is a diagram illustrating processing of calculating the irrationality evaluation fx3 using the estimation model 109.

FIG. 23 is a block diagram illustrating a functional configuration of a learning device 140 that learns an evaluation model 110.

FIG. 24 is a schematic view illustrating the operation of the learning device 140.

FIG. 25 is a diagram illustrating detailed processing of an evaluation derivation unit 103 and a recommendation evaluation unit 104.

FIG. 26 is a schematic view illustrating a timing of learning processing and estimation processing.

FIG. 27 is a block diagram illustrating a functional configuration of a recommendation system 100a in a modification example.

FIG. 28 is a diagram illustrating a specific example of a browsing history storage unit 105a.

FIG. 29 is a schematic view illustrating when a degree of familiarity of each store is calculated from browsing history information.

FIG. 30 is a diagram illustrating a specific example of the browsing history storage unit 105a that stores whether the user has browsed based on a recommendation.

FIG. 31 is a schematic view illustrating when the degree of familiarity of each store is calculated from the browsing history information.

FIG. 32 is a schematic view illustrating processing taking into account both a visit history and a browsing history.

FIG. 33 is a diagram illustrating an example of a hardware configuration of the recommendation system 100 according to the embodiment of the present disclosure.

### DESCRIPTION OF EMBODIMENTS

Embodiments of the present disclosure will be described with reference to the accompanying drawings. If possible, the same parts are denoted by the same reference signs and redundant description thereof will be omitted.

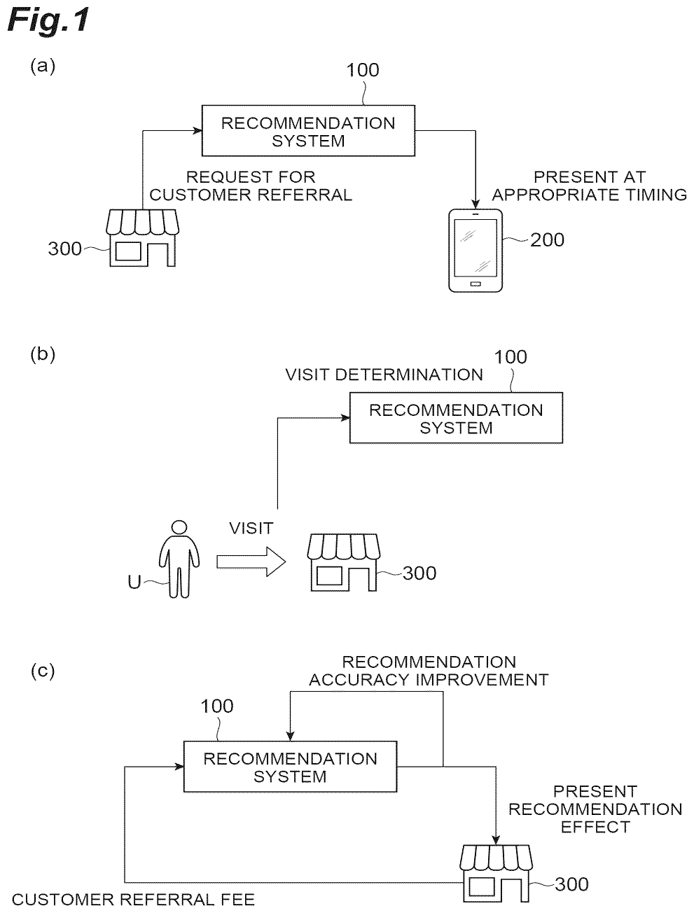

FIG. 1 is a diagram illustrating an overview of the operation of a recommendation system 100 in the present disclosure. The recommendation system 100 transmits a recommendation message to a user terminal 200 in response to a customer referral request from a store 300. The recommendation message is, for example, information regarding the store 300, and when the store 300 is a restaurant, the recommendation information is information including a menu, a limited-time sale, and the like. The recommendation message is information for recommending the store 300 to a user.

In FIG. 1(a), if the recommendation system 100 transmits a recommendation to the user terminal 200 owned by a user U, the user terminal 200 displays (presents) a recommendation message at an appropriate timing.

In FIG. 1(b), the user U visits the store 300. The recommendation system 100 determines the visit. The visit determination is performed by notification from the store 300 or the user terminal 200 to the recommendation system 100.

In FIG. 1(c), the recommendation system 100 provides feedback thereto for recommendation accuracy improvement, and presents a recommendation effect to the store 300. The store 300 pays a customer referral fee to (an operator of) the recommendation system 100 according to the recommendation effect.

In the present disclosure, the recommendation system 100 can calculate an appropriate consideration for the recommendation by transmitting the recommendation message to the user terminal 200 (user U) and calculating the recommendation effect (evaluation) for the recommendation message.

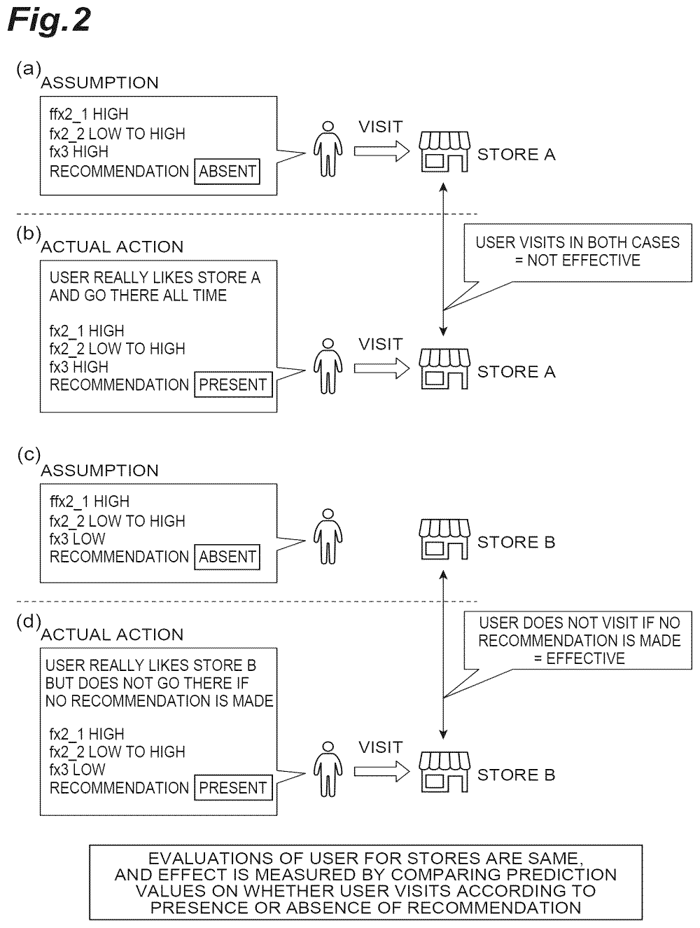

Hereinafter, the concept of a recommendation effect in the present disclosure will be described. FIG. 2 is a schematic view illustrating the concept of a recommendation effect. FIG. 2(a) is a schematic view assuming that the user U has visited the store A when no recommendation has been made. FIG. 2(b) is an actual schematic view illustrating the user U having visited the store A when a recommendation has been made.

As illustrated in FIGS. 2(a) and 2(b), when the user U has visited the store A regardless of the presence or absence of a recommendation, determination is made that the recommendation is not effective.

In FIG. 2(c), it is assumed that, when a recommendation is not made, the user U will not visit a store B. On the other hand, in FIG. 2(d), when a recommendation has been made and when the user U actually has visited the store B, determination can be made that the user U will not visit when no recommendation is made, and determination is made that the recommendation is effective.

As understood from FIG. 2, in the present disclosure, when the evaluations of the user for stores are the same, the effect of a recommendation is measured by comparing prediction values on whether the user visits according to the presence or absence of the recommendation. A store evaluation fx2 (fx2_1 and fx2_2) and an irrationality evaluation fx3 in FIG. 2 indicate evaluation parameters of the user. The store evaluation fx2 indicates an attribute evaluation fx2_1 based on a degree of coincidence of interest and preference and a constraint evaluation fx2_2 for a visit situation of the user. Details will be described below.

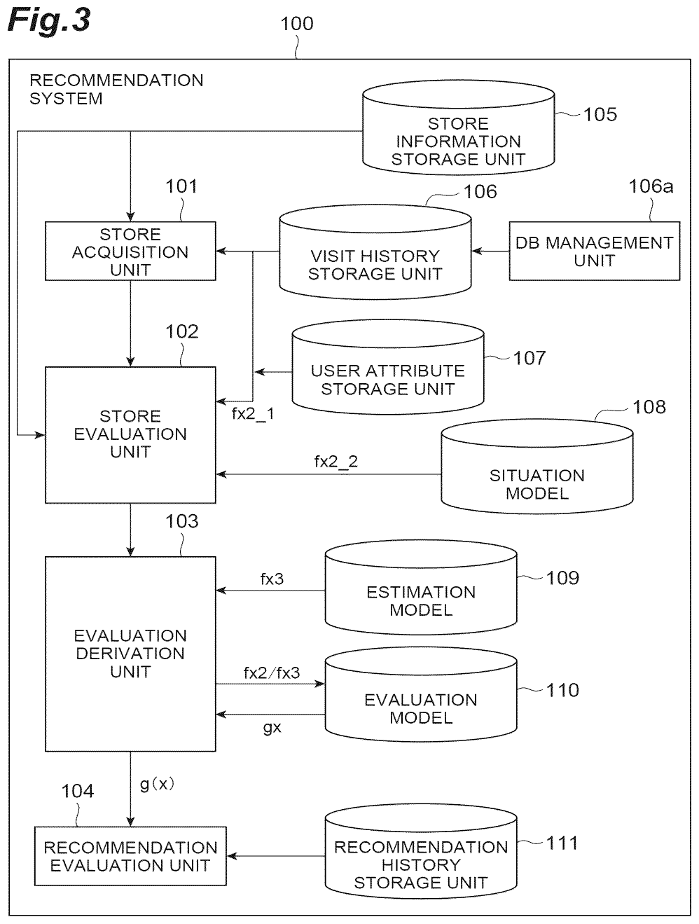

FIG. 3 is a block diagram illustrating a functional configuration of the recommendation system 100 in the present disclosure. The recommendation system 100 of the present disclosure includes a store acquisition unit 101, a store evaluation unit 102, an evaluation derivation unit 103, a recommendation evaluation unit 104, a store information storage unit 105, a visit history storage unit 106, a DB management unit 106a, a user attribute storage unit 107, a situation model 108, an estimation model 109, an evaluation model 110, and a recommendation history storage unit 111.

The store acquisition unit 101 is a part that acquires a visit candidate store fx1 of the user. The store acquisition unit 101 acquires familiar stores to be selected by the user from the store information storage unit 105 and the visit history storage unit 106, and acquires the visit candidate store fx1 that the user will visit, on the basis of the familiar stores. Details of acquisition processing of the visit candidate stores will be described below.

The store evaluation unit 102 is a part that calculates the store evaluation fx2 for each store of the user on the basis of visit history information stored in the visit history storage unit 106, user attribute information stored in the user attribute storage unit 107, and store information stored in the store information storage unit 105. The store evaluation unit 102 calculates the attribute evaluation fx2_1 based on the degree of coincidence of interest and preference of each user with the store on the basis of the attribute of each user. The store evaluation unit 102 calculates the constraint evaluation fx2_2 of each store based on a visit situation of each user and information of each store.

The evaluation derivation unit 103 is a part that inputs the attribute evaluation fx2_1, the constraint evaluation fx2_2, and the irrationality evaluation fx3 to the evaluation model 110 and acquires a visit likelihood evaluation g(x) as an output. The irrationality evaluation fx3 is acquired from the estimation model 109 on the basis of last visit information of the user for a recommended store and another store. The evaluation derivation unit 103 may input at least one of the attribute evaluation fx2_1, the constraint evaluation fx2_2, and the irrationality evaluation fx3, and the estimation model 109 may also be trained using at least one of the attribute evaluation fx2_1, the constraint evaluation fx2_2, and the irrationality evaluation fx3.

The recommendation evaluation unit 104 is a part that evaluates a recommendation effect on the basis of a difference between a visit likelihood evaluation g(x) for a visited store (for example, the store A) and a visit likelihood evaluation g(x) assuming that no recommendation has been made. The recommendation evaluation unit 104 refers to the recommendation history storage unit 111 and does not perform recommendation evaluation for a store (for example, the store A) recommended previously or within a prescribed period.

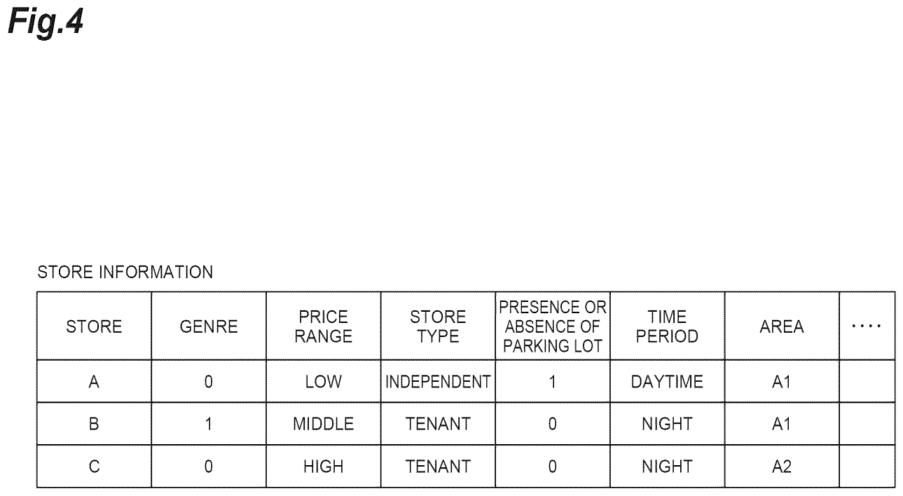

The store information storage unit 105 is a part that stores the store information. The store information is attribute information such as a genre and a price range of the store. FIG. 4 is a diagram illustrating a specific example of the store information. As illustrated in the drawing, the store information includes, for each store, a genre, a price range, a store type, the presence or absence of a parking lot, a time period during which the store is open, an area, and the like. The genre indicates a classification of a store such as a restaurant, a clothing store, or a general store.

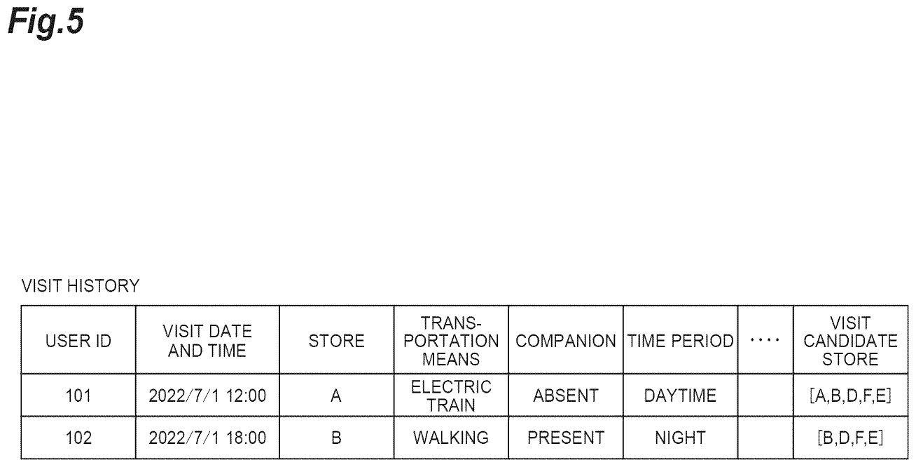

The visit history storage unit 106 is a part that stores the visit history information of each user. FIG. 5 is a diagram illustrating a specific example of the visit history information. As illustrated in the drawing, the visit history information is configured in such a manner that a user ID, a visit date and time, a store, transportation means, a companion, a time period, and a visit candidate store are associated with each other.

The DB management unit 106a is a part that stores the visit history information in the visit history storage unit 106. The DB management unit 106a acquires visit information (the same information as the visit history information) from the user terminal 200 or the store that the user has visited each time the user terminal 200 visits.

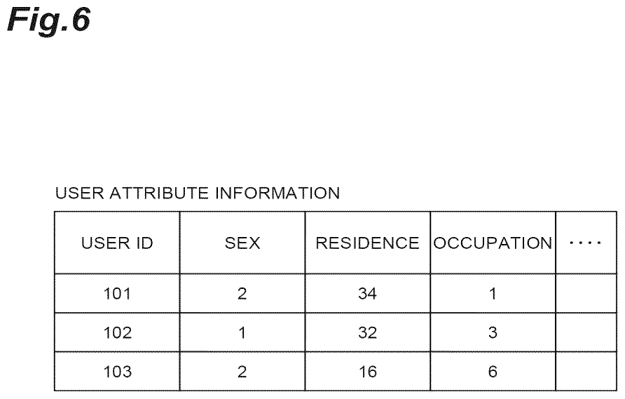

The user attribute storage unit 107 is a part that stores the user attribute information of each user. FIG. 6 is a diagram illustrating a specific example of the user attribute information. As illustrated in the drawing, the user attribute information includes a user ID, sex, residence, occupation, and the like. In addition to such information, an age, a family structure, and the like may be included.

The situation model 108 is an estimation model prepared for each visit situation of the user, and is a machine learning model that receives the visit situation of the user as an input and outputs the evaluation fx2_2 for the store. The situation model 108 is generated for each visit situation on the basis of a visit history (transportation means, the presence or absence of a companion, a time period, and the like) in all areas of each user, and is trained with the visit situation of the user as an explanatory variable and the presence of absence of visit to each store as an objective variable. Accordingly, the output of the situation model 108 indicates a visit likelihood for each store.

The estimation model 109 is a machine learning model that receives last visit information of the user as an input and outputs the irrationality evaluation fx3 indicating a visit likelihood for each store. The estimation model 109 is generated by machine learning with last visit information including visit frequency information (the number of repetitions, the number of elapsed days, a genre, and the like) of the user for the store and last situation information (weather, a previous price range, . . . , the presence or absence of a visit to the store, and the like) of the user at that time as an explanatory variable and the presence or absence of a visit as an objective variable. The learning of the estimation model will be described below.

The evaluation model 110 is a machine learning model that receives the store evaluation fx2 (fx2_1 and fx2_2) and the irrationality evaluation fx3 as an input and outputs the visit likelihood evaluation g(x). The evaluation model 110 is generated by machine learning with the store evaluation fx2 and the irrationality evaluation fx3 as an explanatory variable and the presence or absence of a visit as an objective variable. The learning of the evaluation model will be described below.

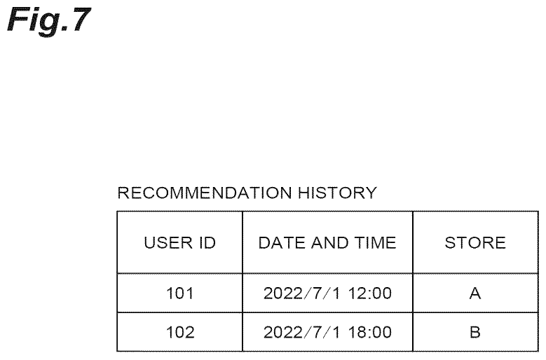

The recommendation history storage unit 111 is a part that stores recommendation history information for each user. FIG. 7 is a diagram illustrating a specific example of the recommendation history information. As illustrated in the drawing, the recommendation history information includes a user ID of a user who receives a recommendation, a date and time on which the recommendation is made, and a store for which the recommendation is made.

In calculating the attribute evaluation fx2_1, in place of the above-described configuration and processing, the following configuration and processing may be applied. For example, an attribute model is, for example, attribute information of each store prepared for each store, and is generated on the basis of the attribute of the user who visits each store. Then, the attribute evaluation fx2_1 may be calculated using the attribute model. Learning processing of the situation model 108 and the attribute model for calculating the store evaluation fx2 may be performed at this timing.

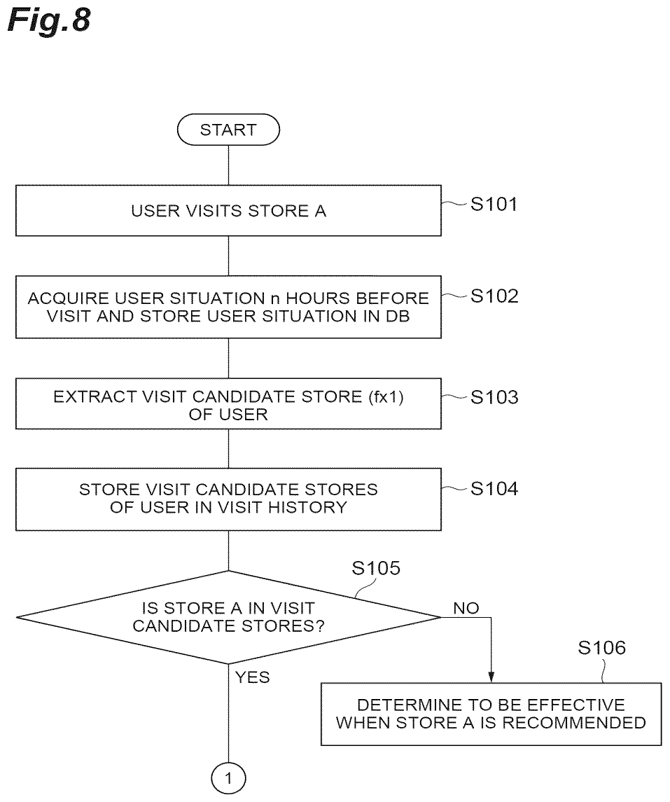

The operation of the recommendation system 100 configured in this way will be described. FIG. 8 is a flowchart illustrating acquisition of visit candidate stores in the recommendation system 100.

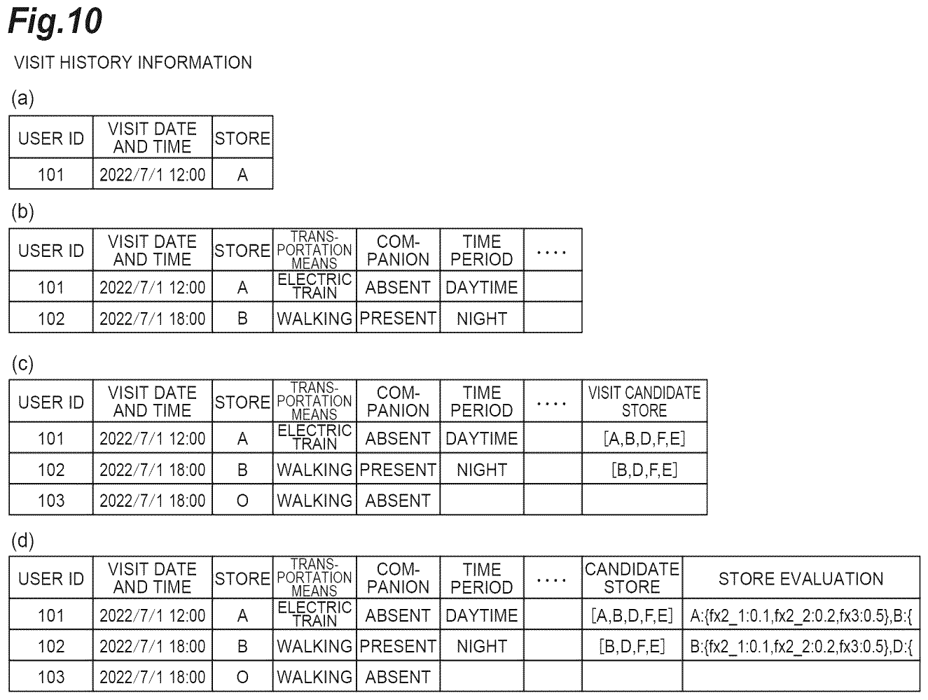

If the user visits the store A, the user ID, the visit date and time, and the visited store A are transmitted from the user terminal 200 to and stored in the visit history storage unit 106 (S101). Such processing is controlled by the database (DB) management unit 106a. FIG. 10(a) illustrates the visit history information of the visit history storage unit 106.

If such processing is executed, the DB management unit 106a acquires a user situation n hours before the visit, and further stores the user situation in the visit history storage unit 106 in association with the visit history information (S102). FIG. 10(b) illustrates visit history information reflecting the user situation. Herein, the user situation includes the transportation means of the user, the presence or absence of a companion, and the time period. The DB management unit 106a may acquire such information directly from the user terminal 200 by a user operation or may acquire information acquired on the basis of a sensor or the like of the user terminal 200. The DB management unit 106a may estimate the transportation means, the presence or absence of a companion, and the like on the basis of positional information of a DB that performs position registration of the user terminal 200. In the present disclosure, the DB management unit 106a acquires information n hours before the visit. The user terminal 200 or a terminal management server (not illustrated) normally stores user situations, and the DB management unit 106a can acquire information n hours ago among the user situations.

The store acquisition unit 101 acquires the visit candidate store fx1 of the user (S103), and stores the visit candidate stores in the visit history storage unit 106 (S104). FIG. 10(c) illustrates visit history information reflecting the visit candidate stores.

Here, the evaluation derivation unit 103 determines whether the store A is included in the visit candidate stores (S105). Here, when determination is made that the store A is not included, and the recommendation evaluation unit 104 determines that the store A is recommended, the recommendation evaluation unit 104 determines that the recommendation is effective, and the process ends (S106). On the other hand, if determination is made that the store A is included, the evaluation derivation unit 103 performs more detailed evaluation processing.

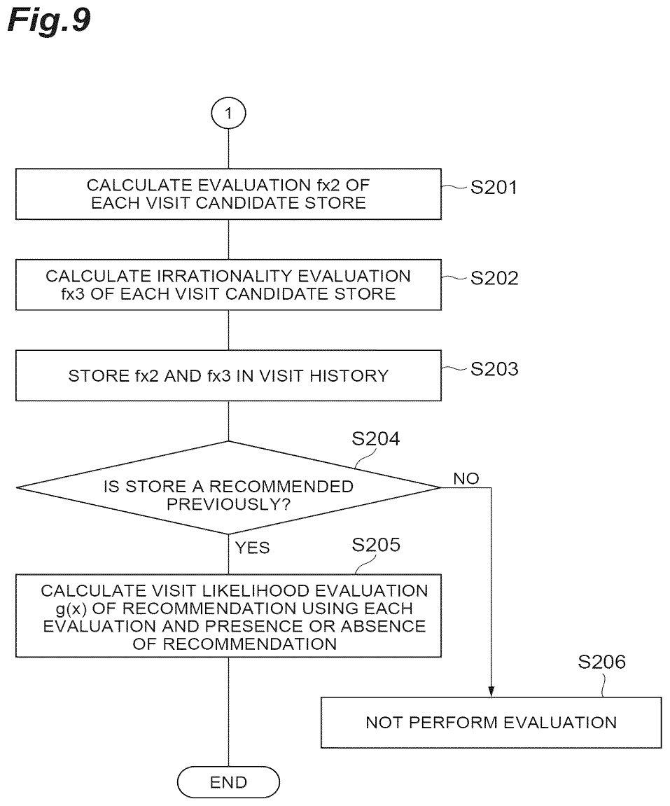

FIG. 9 is a flowchart illustrating detailed processing of recommendation evaluation in the recommendation system 100.

The store evaluation unit 102 calculates the evaluation fx2 for each visit candidate store of a target user (S201). In more detail, the store evaluation unit 102 calculates the attribute evaluation fx2_1 and the constraint evaluation fx2_2. Learning processing of the situation model 108 for calculating the store evaluation fx2 may be performed at this timing.

Then, the evaluation derivation unit 103 calculates the irrationality evaluation fx3 for each visit candidate store on the basis of statistical information including a last action of the user (S202).

The evaluation derivation unit 103 stores the attribute evaluation fx2_1, the constraint evaluation fx2_2, and the irrationality evaluation fx3 of the target user in the visit history storage unit 106 (S203). FIG. 10(d) is a diagram illustrating visit history information reflecting the attribute evaluation fx2_1, the constraint evaluation fx2_2, and the irrationality evaluation fx3 of the target user. Learning processing of the estimation model 109 for calculating the irrationality evaluation fx3 may be performed at this timing.

The evaluation derivation unit 103 determines whether the visited store (for example, the store A) is recommended to the user previously (or within a prescribed period), with reference to the recommendation history storage unit 111 (S204).

If determination is made that the store is recommended, the evaluation derivation unit 103 calculates a visit likelihood g(x) using each evaluation (fx2 and fx3) and calculates a recommendation effect using the visit likelihood g(x) (S205). Specifically, the recommendation effect is calculated by further calculating a visit likelihood g(x) assuming that the store is not recommended and obtaining a difference between the visit likelihood g(x) when the store is recommended and the visit likelihood g(x) assuming that the store is not recommended. Learning processing of the evaluation model 110 for calculating the visit likelihood g(x) may be performed at this timing.

Here, if determination is made that the store is not recommended, the evaluation derivation unit 103 does not perform recommendation evaluation (S206).

In this manner, the recommendation system 100 can obtain an effect of a recommendation. An operator that transmits a recommendation can determine a transmission fee for the recommendation on the basis of the effect for the recommendation and perform rational operation.

Next, a way of obtaining the visit candidate store fx1, the store evaluation fx2, the irrationality evaluation fx3, and the visit likelihood g(x) described above will be described.

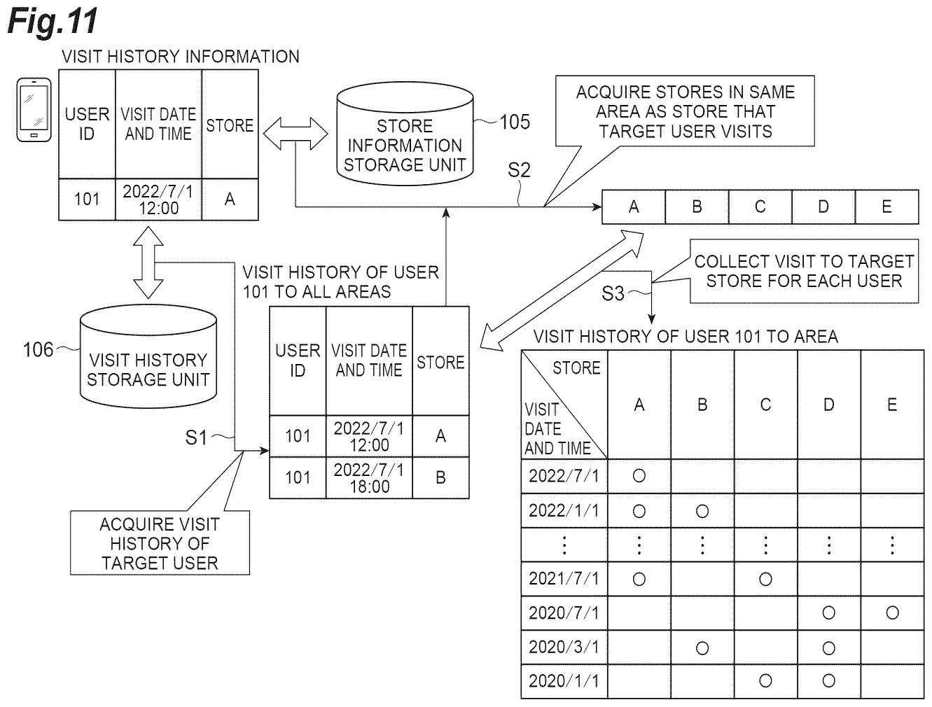

FIGS. 11 to 13 are diagrams illustrating a way of obtaining the visit candidate store fx1. FIG. 11 is a schematic view illustrating processing of acquiring a target visit candidate store fx1 by the store acquisition unit 101.

As illustrated in the drawing, the store acquisition unit 101 refers to the visit history storage unit 106 to acquire a visit history (see FIG. 10(a)) of a target user (in FIG. 11, a user 101) to all areas (S1). The store acquisition unit 101 acquires stores in the same area as a currently visited store from the visit history (S2). Then, the store acquisition unit 101 collects the stores for each target user to acquire a visit history to the area and generates a visit history table (S3).

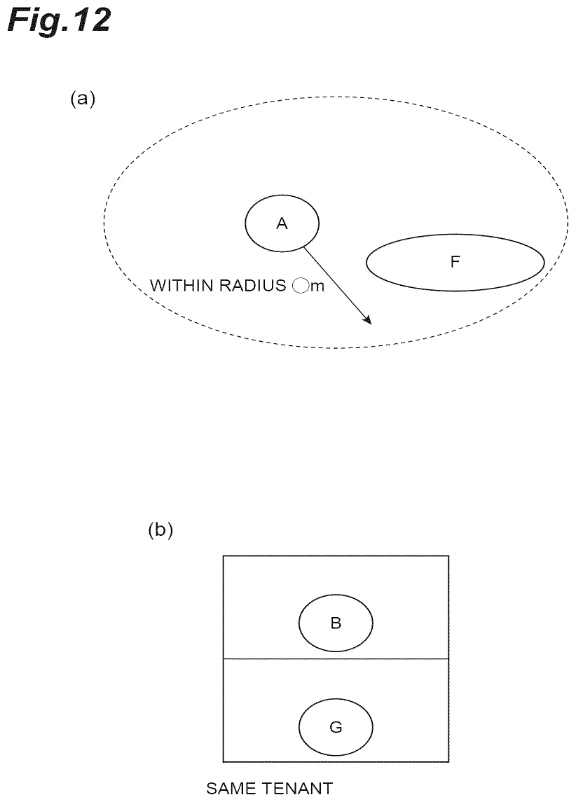

FIG. 12 is a diagram illustrating a nearby store near a target store. As illustrated in the drawing, a nearby store may be included as a visit candidate store. In the present disclosure, a nearby store within a prescribed radius such as a 10 m radius centering on the target store is a visit candidate store (FIG. 12(a)). A store in the same tenant as the target store is a visit candidate store as a nearby store (FIG. 12(b)). Information on whether the store is in the same tenant may be determined on the basis of a tenant name included in the store information. In FIG. 4, the tenant name is omitted.

The present disclosure is not limited to the above-described method, and there are various methods as long as a store has been visited previously and the user may be familiar with a store from a previous visit log. A familiar store inferred from a visit log or the like of a nearby store may be employed.

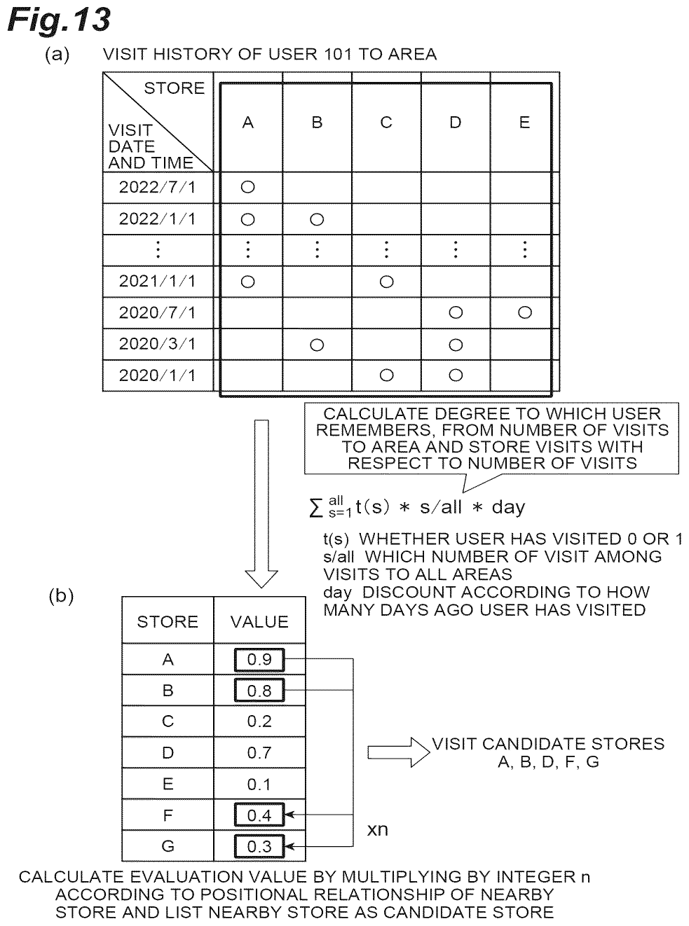

FIG. 13 is a schematic view illustrating when an evaluation value of a visit candidate store is obtained from the generated visit history table. FIG. 13(a) illustrates the visit history table. As illustrated in the drawing, in the visit history table, a visit history (frequency) of each store is described. From FIG. 13(a), stores A to E described below give the following impressions to the user.
Store A: I have been coming here a lot recently and am making coming here habit
Store B: I came here recently in fits and starts→I remember because I came here recently
Store C: I did not come here recently & I came here previously in fits and starts→I don't remember much
Store D: I have gone there many times before→Maybe I remember
Store E: I have gone there once before→I don't remember

The store acquisition unit 101 calculates a degree of remembering (degree of familiarity) of the user for each store on the basis of the number of visits to the area and store visits with respect to the number of visits to the area according to the visit history table. The number of visits to the area is obtained from the visit history information. A degree of remembering (degree of familiarity) is based on the following expression. According to the expression, the degree of remembering of the user is obtained on the basis of the number of visits to the area and a visit interval. The following expression is made such that the longer the visit interval is, the lower the degree of remembering becomes.

$${\sum }_{s = 1}^{all} t ( s ) * s / all * day \qquad [ Equation 1 ]$$

t(s): whether the user has visited 0 or 1
s/all: which number of visit among visits to all areas
day: a discount rate set in advance according to how many days ago the user has visited
s: an order of visit to a certain area. first, second, . . . , and the like

The degree of remembering is, of course, not limited to the above expression, and can be determined on the basis of the visit frequency and the visit interval or one of the visit frequency and the visit interval. The above-described day is set as a discount rate (coefficient) for discounting an evaluation value on the basis of the number of elapsed days after a visit. The coefficient is determined to become low according to the number of elapsed days. For example, the coefficient becomes ⅓ when three days have elapsed and 1/10 when ten days have elapsed.

FIG. 13(b) is a diagram illustrating a value of each visit candidate store acquired by the store acquisition unit 101. As illustrated in the drawing, nearby stores F and G of stores A to E are added to a store group. For the stores A to E, an evaluation value (a degree to which the user remembers; a degree of familiarity) as a store as described above is obtained. Since the stores F and G are not visited, there are no evaluation values. For this reason, the store acquisition unit 101 calculates the evaluation values of the nearby stores F and G by multiplying the evaluation values of the stores A and B derived with the nearby stores F and G as a nearby store by a prescribed coefficient. For a store with a high evaluation value, the user is likely to be familiar with a nearby store too. Thus, the nearby store is added to a candidate. The visit candidate stores of the user are extracted using a threshold that will allow “stores having the numerical value higher than the threshold to be listed as candidates”.

The store acquisition unit 101 selects stores having the evaluation value higher than the threshold as the visit candidate store fx1. The evaluation value may be used in a visit likelihood evaluation g(x) described below. As a result, it is possible to calculate an evaluation with higher accuracy by handling the evaluation values of the stores of the visit candidate store fx1 equally to the evaluations fx2 and fx3 described below as well as calculating the stores as the candidate stores.

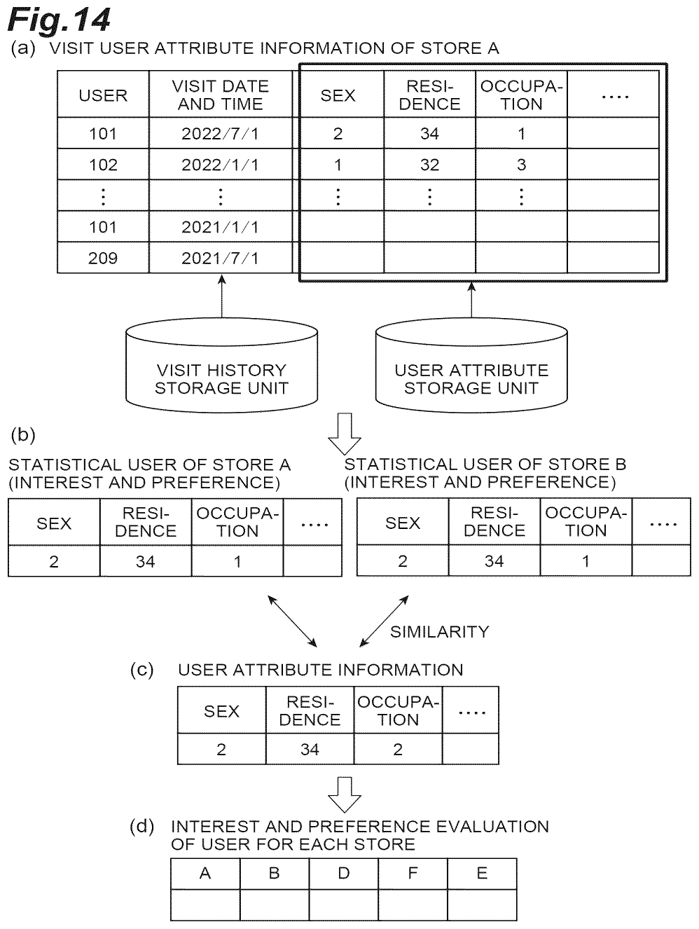

FIG. 14 is a diagram illustrating a way of obtaining the store evaluation fx2. As a preparation, the following processing is performed. As illustrated in FIG. 14(a), users who have visited each store and user attribute information are acquired on the basis of the visit history information of the visit history storage unit 106 and the user attribute information of the user attribute storage unit 107. In FIG. 14(a), for example, attribute information (visit user attribute history) of users who have visited the store A is acquired.

Then, as illustrated in FIG. 14(b), statistical user information is generated for each store. The statistical user information is information that is generated on the basis of the visit user attribute history, and is based on an average value, a median value, or a most frequent value. Items such as residence and occupation for which an average value or a median value cannot be obtained may be based on a most frequent value.

Such processing is performed by a store attribute generation unit (not illustrated). This part may be provided in the recommendation system 100 or may be provided in an external device.

FIG. 14(c) is a diagram illustrating user attribute information. A calculation process of the attribute evaluation fx2_1 for the store is illustrated using FIGS. 14(b) and 14(c). The store evaluation unit 102 obtains a similarity between the user attribute information (FIG. 14(c)) of the target user and statistical user information (visit user attribute history, FIG. 14(b)) of each store, and sets the similarity as the attribute evaluation fx2_1.

More specifically, the store evaluation unit 102 acquires the user attribute information to be a target of the evaluation of the recommendation effect with reference to the user attribute storage unit 107. The store evaluation unit 102 calculates the evaluation fx2_1 for each store by calculating the similarity between the attribute information of each store of the visit candidate store fx1 and the attribute information of the user. The similarity is obtained by a cosine similarity, but is not limited thereto.

In regard to the attribute evaluation fx2_1, a visit prediction value that is calculated from the attribute of the user who visits the store and the presence or absence of the visit, or the like can be used as an evaluation value. That is, a model that inputs the attribute of the user using an attribute evaluation model and estimates a visit likelihood for the store may be used. The attribute evaluation model is trained with the user attribute as an explanatory variable and the presence or absence of the visit as an objective variable. The attribute evaluation fx2_1 is calculated from the attribute of the user who visits the store and the presence or absence of the visit, and a method of calculating the store evaluation based on the attribute of the user is not limited to the above-described method.

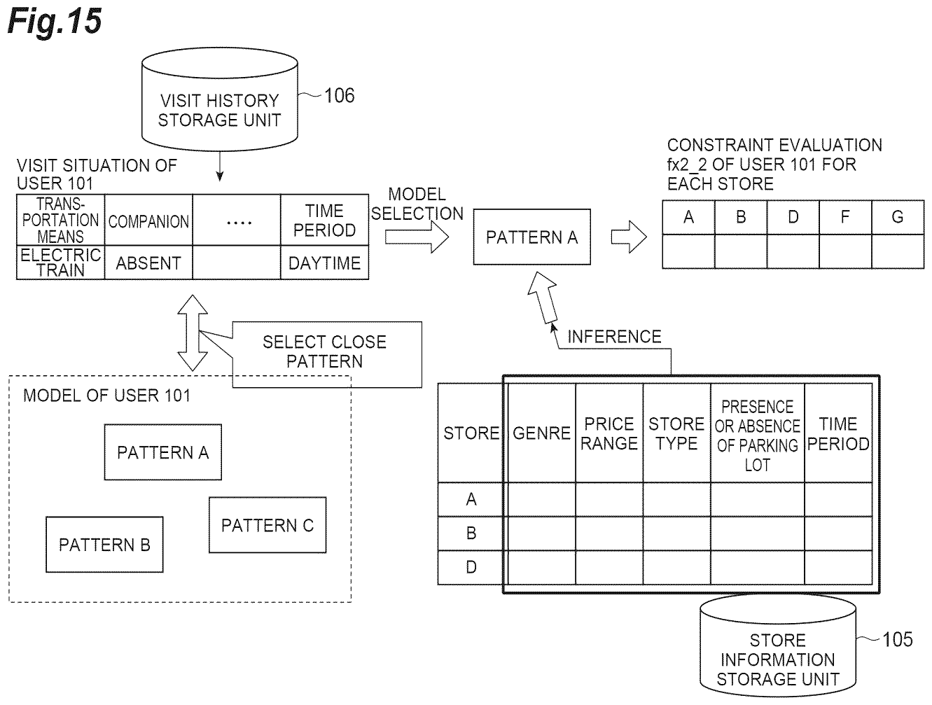

Next, a calculation method of the constraint evaluation fx2_2 will be described. FIG. 15 is a schematic view illustrating the calculation method. The store evaluation unit 102 acquires a visit situation of a target user (user 101) from the visit history storage unit 106. It is assumed that the situation information is based on n hours before a time when the user visits the store. Then, the situation model 108 created for each user is selected according to a situation. A plurality of situation models 108 are prepared in advance according to situation patterns, and the store evaluation unit 102 selects the situation model 108 suitable for a pattern closest to the visit situation of the user n hours ago.

Then, the store evaluation unit 102 acquires the store information of the visit candidate store fx1 with reference to the store information storage unit 105. Then, the store evaluation unit 102 inputs the store information to the situation model 108. The store evaluation unit 102 acquires the constraint evaluation fx2_2 for each store output from the situation model 108.

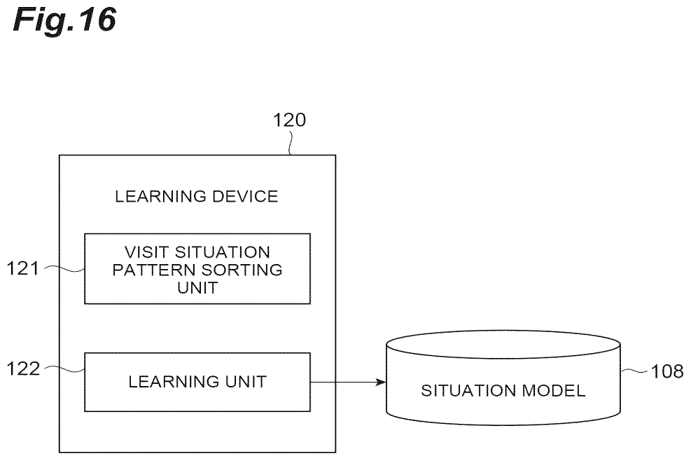

Next, a generation method of the situation model 108 will be described. FIG. 16 is a block diagram illustrating a functional configuration of a learning device 120 that learns the situation model 108. The learning device 120 may be provided in or may be present separately from the recommendation system 100. The learning device 120 includes a visit situation pattern sorting unit 121 and a learning unit 122.

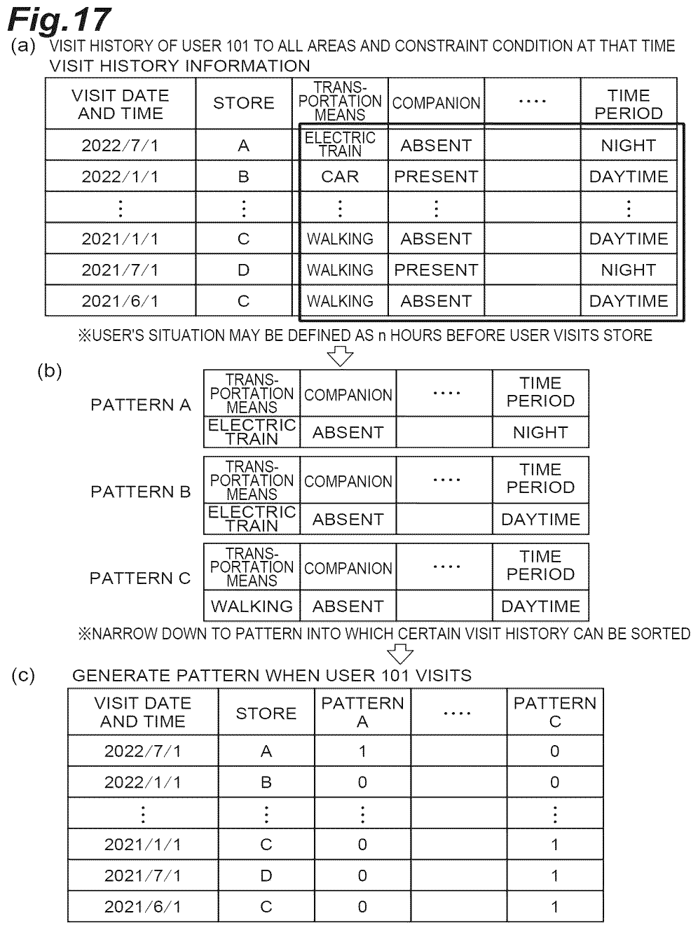

FIG. 17 is a diagram illustrating processing for preparation to generate the situation model 108. As illustrated in FIG. 17(a), the visit situation pattern sorting 121 acquires the situation information (transportation means, companion, . . . , time period, and the like) with reference to the visit history storage unit 106. The situation information indicates a situation n hours before the user visits the store as described above.

Then, as illustrated in FIG. 17(b), the visit situation pattern sorting unit 121 sorts the situation information for each pattern. The sorting is performed by narrowing down the visit situation pattern to a pattern into which a certain visit history (for example, five or more) can be sorted.

As illustrated in FIG. 17(c), the learning unit 122 generates a situation pattern when the user visits. The learning unit 122 determines a situation pattern for a visited store, and sets a visited store in each pattern as 1 and an unvisited store as 0.

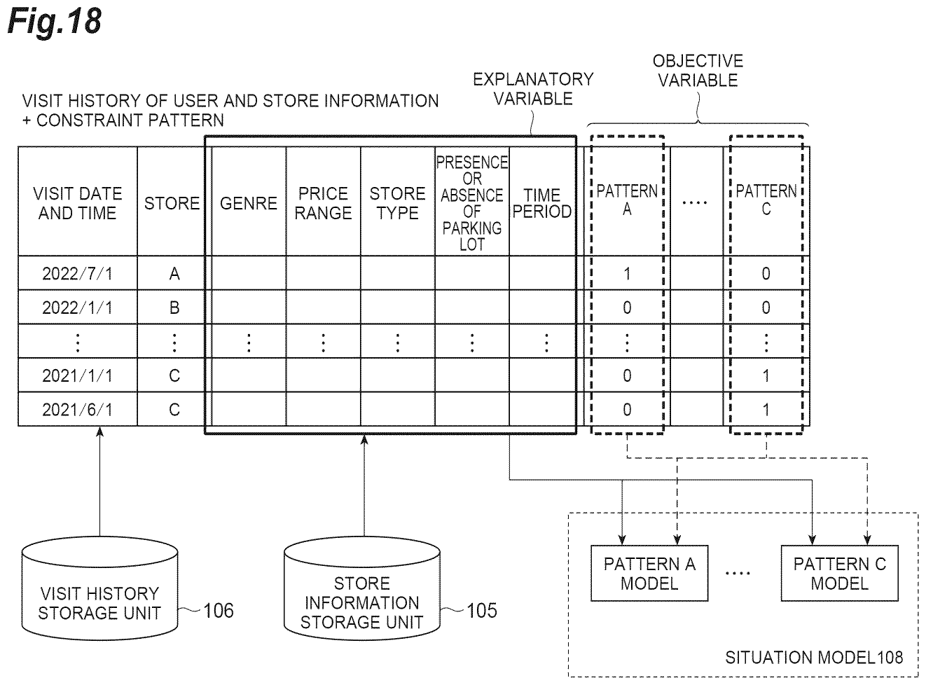

FIG. 18 is a diagram illustrating a specific example of learning processing of the situation model 108. The learning unit 122 browses the store information from the store information storage unit 105 to each store for each store stored in the visit history storage unit 106, and gives the store information to each pattern (FIG. 17(c)). Then, the learning unit 122 learns the situation model 108 for each pattern by machine learning with the store information as an explanatory variable and the presence or absence of the visit as an objective variable. The situation model 108 is trained for each pattern of each user.

A learning method of the situation model 108 is not limited to the above-described method. The constraint evaluation fx2_2 may be calculated from a previous situation of the user who visits the store and the presence or absence of the visit, and a method of calculating the evaluation for the store based on the situation of the user is not limited to the above-described method.

An estimation model that takes into account both the attribute evaluation fx2_1 and the constraint evaluation fx2_2 may be used. That is, a model in which the degree of coincidence of preference between the user and the store is not divided into fx2_1 and fx2_2, and is calculated as one evaluation value may be used.

The learning device 120 performs the learning processing using the visit history information of the visit candidate store upon the visit each time the target user visits, without depending on the presence or absence of the recommendation, but may perform the learning processing collectively at a certain interval.

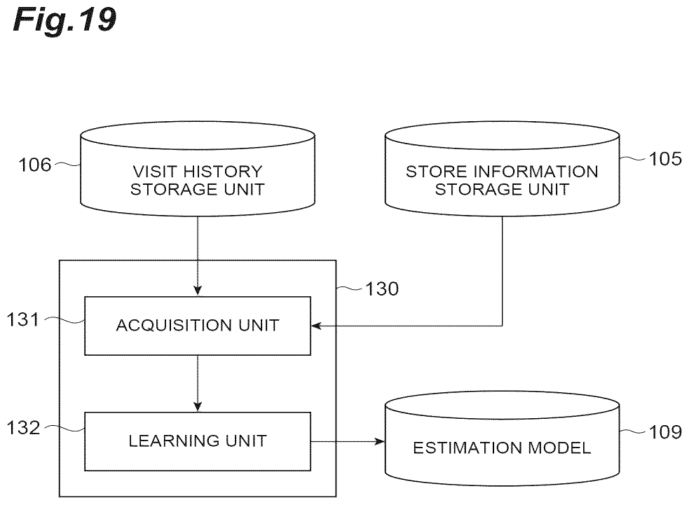

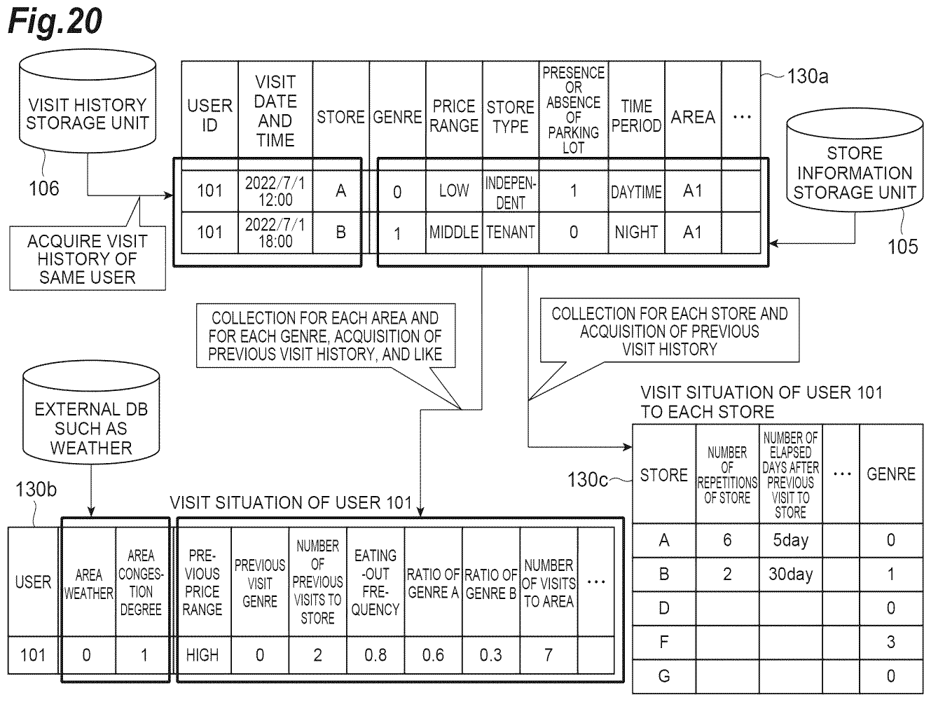

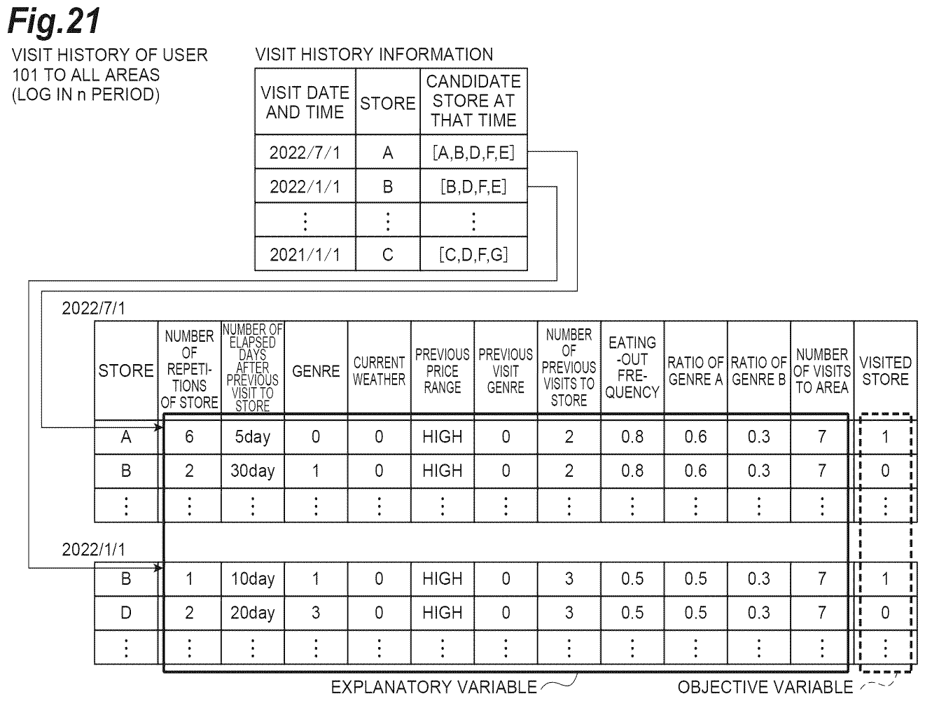

Next, the irrationality evaluation fx3 will be described. FIG. 19 is a block diagram illustrating a functional configuration of a learning device 130 that learns the estimation model 109 for obtaining the irrationality evaluation fx3. FIG. 20 is a schematic view illustrating generation of various management tables. FIG. 21 is a diagram illustrating learning processing using various management tables.

As illustrated in FIG. 20, the acquisition unit 131 acquires the visit history of the same user with reference to the visit history storage unit 106. The acquisition unit 131 acquires the store information of the store in the visit history with reference to the store information storage unit 105 and generates an associated store information table 130a.

The acquisition unit 131 performs collection for each area and for each genre to acquire a previous visit history information table 130b. The “previous visit history information table 130b” includes statistical information based on a previous comparison situation (previous price range and the like) that is a visit situation in comparison with a previous store, which the user has visited, a store visit situation that is a visit situation (eating-out frequency, genre A ratio, and the like) for a store, which the user has visited, and external information that is an area congestion degree and area weather taken out from an external server. At least one of the previous comparison situation, the store visit situation, and the external information may be provided.

The acquisition unit 131 collects the visit situation of the user for each store for each store and acquires the previous visit history to acquire a visit situation table 130c. The “visit situation table 130c” is statistical information indicating a visit history situation such as a visit frequency and a visit interval of each store.

As illustrated in FIG. 21, the learning unit 132 acquires the visit candidate store from the visit history storage unit 106, and learns the estimation model 109 by machine learning with information in which the previous comparison situation, the store visit situation, and the external information are associated with the visit history situation of the visit candidate store, as an explanatory variable and information on whether the user has actually visited, as an objective variable. In regard to information on whether the user has visited, when the user has visited, 1 is set, and when the user has not visited, 0 is set, as an objective variable. The evaluation value of each store obtained in acquiring the visit candidate store fx1 may be used as an explanatory variable.

As a result, it is possible to generate the estimation model 109 for calculating a visit likelihood based on irrational information according to the mood of the user at that time, that is, an irrationality evaluation. The learning of the estimation model 109 is not limited to the above description, and another model that calculates a visit prediction value of each store from a visit tendency such as the genre and the area of the user may be trained and constructed.

The learning device 130 performs the learning processing using the visit history information each time the target user visits, without depending on the presence or absence of the recommendation, but may perform the learning processing collectively at a certain interval.

In the present disclosure, the statistical information is stored as information that is a criterion for calculating whether the user is likely to go to the store at that time. Such statistical information is information that is a criterion for obtaining a feature quantity related to the mood of the user. In the present disclosure, while the statistical information such as the last visit history and the previous visit frequency of the user is used, since the purpose is to calculate the visit likelihood according to the mood of the user on the day, other kinds of information may be included.

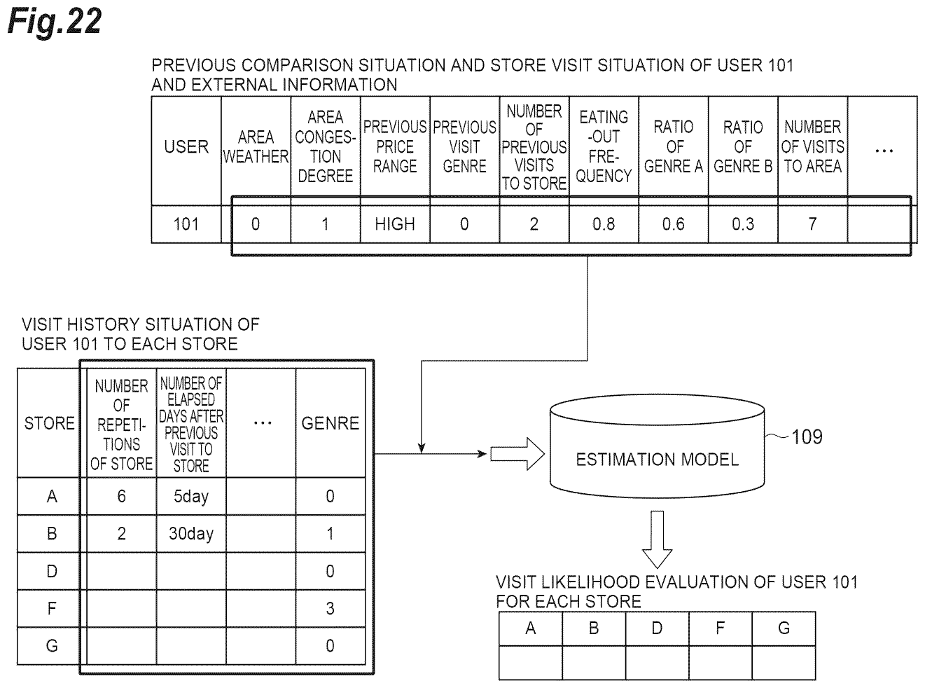

FIG. 22 is a diagram illustrating processing of calculating the irrationality evaluation fx3 using the estimation model 109. The evaluation derivation unit 103 can calculate the visit likelihood evaluation g(x) of the target user for each store by inputting the previous comparison situation, the store visit situation, and the external information to the estimation model 109 for the target user. As described above, the estimation model 109 may be trained using the evaluation value of each store as an explanatory variable. The present disclosure is not limited thereto, and a final visit likelihood g(x) may be obtained by adding or multiplying the visit likelihood evaluation g(x) for each store and the evaluation value used in acquiring the visit candidate store fx1.

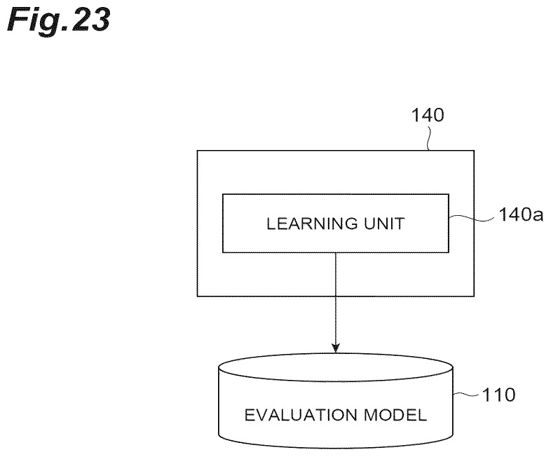

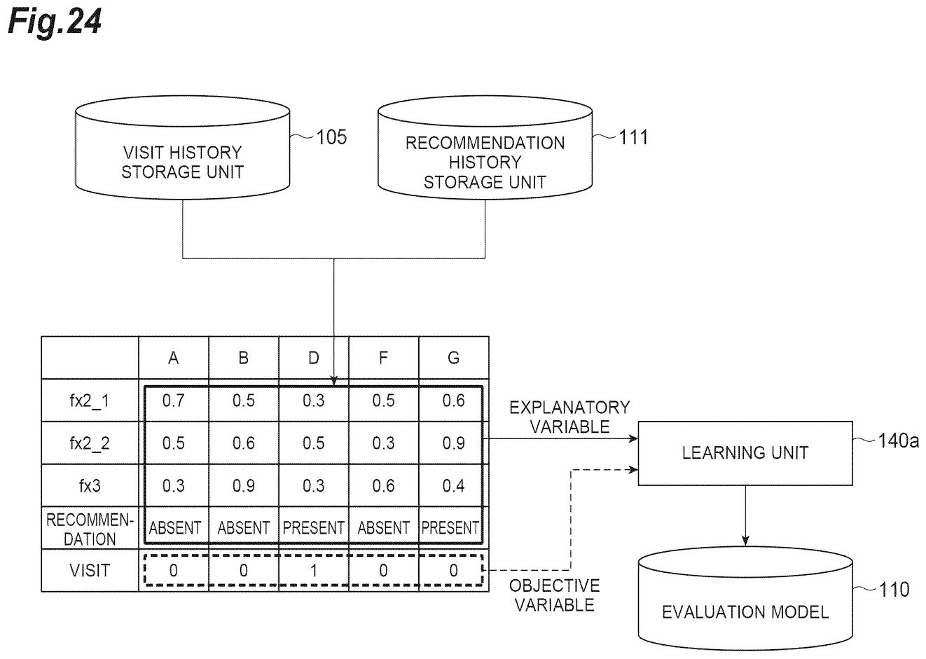

Next, the learning of the evaluation model 110 will be described. FIG. 23 is a block diagram illustrating a functional configuration of a learning device 140 that learns the evaluation model 110. FIG. 24 is a schematic view illustrating the operation of the learning device 140. The learning device 140 includes a learning unit 140a. The learning unit 140a takes out the store evaluation fx2, the irrationality evaluation fx3, and the recommendation history calculated as described above from a database in which the store evaluation fx2, the irrationality evaluation fx3, and the recommendation history are stored in association with a result of the visit of each store at that time, and learns by machine learning with the store evaluation fx2, the irrationality evaluation fx3, and the recommendation history as an explanatory variable and the result of the visit of each store as an objective variable. As a result, the evaluation model 110 is generated.

The learning device 140 performs the learning processing using the store evaluation fx2 and the irrationality evaluation fx3 calculated using the visit history information each time the target user visits, without depending on the presence or absence of the recommendation, but may perform the learning processing collectively at a certain interval.

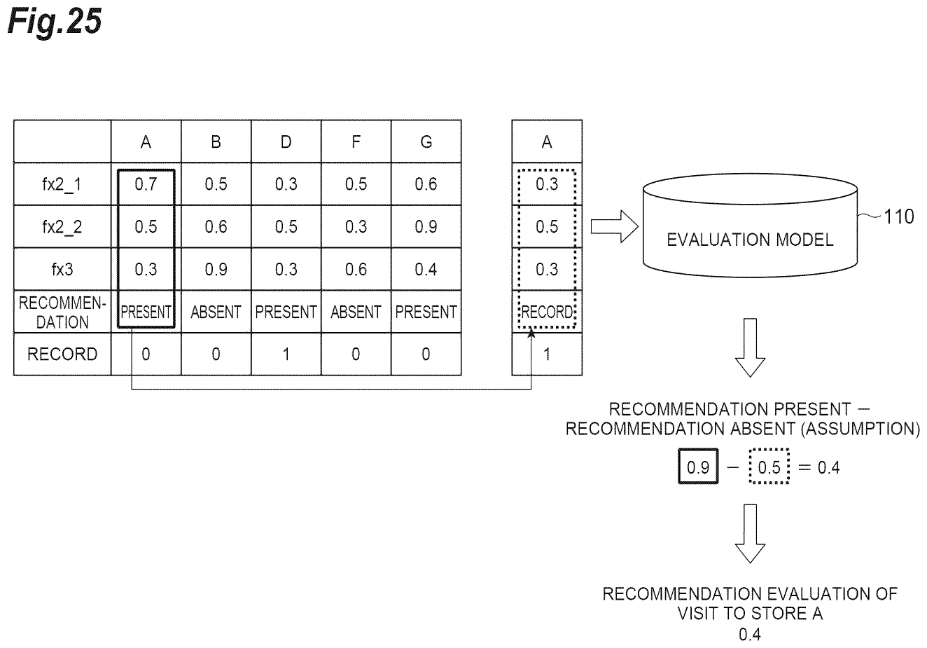

Next, details of evaluation processing will be described. FIG. 25 is a diagram illustrating detailed processing of the evaluation derivation unit 103 and the recommendation evaluation unit 104. As described above, the evaluation derivation unit 103 inputs, to the evaluation model 110, the store evaluation fx2, the irrationality evaluation fx3, and information indicating the presence of the recommendation, for the recommended store, and the evaluation model 110 outputs the visit likelihood g(x). The evaluation derivation unit 103 inputs, to the evaluation model 110, the store evaluation fx2, the irrationality evaluation fx3, and information indicating the absence of the recommendation for the recommended store, and the evaluation model 110 outputs the visit likelihood evaluation g(x) assuming that a recommendation is absent.

The recommendation evaluation unit 104 calculates a difference between the visit likelihood evaluation g(x) for the recommended store and the visit likelihood evaluation g(x) assuming that a recommendation is absent. The difference becomes the recommendation evaluation for the recommended store. An operator that operates recommendation transmission can determine a recommendation fee on the basis of the recommendation evaluation.

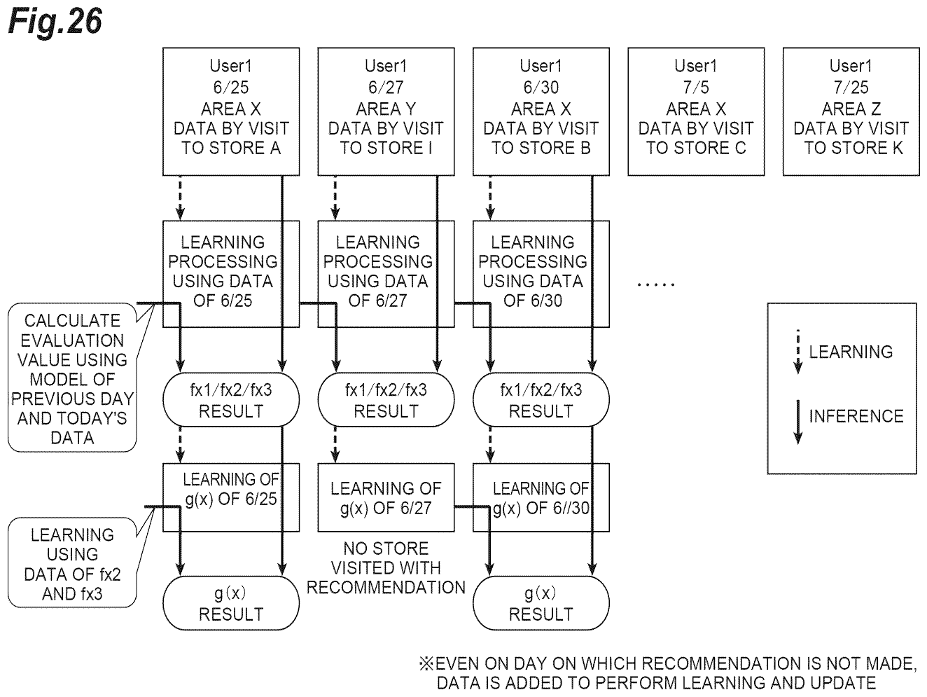

Next, timings of the estimation processing and the learning processing will be described. FIG. 26 is a schematic view illustrating a timing of the estimation processing and the learning processing. As illustrated in the drawing, if the user visits a certain store, the recommendation system 100 calculates the visit candidate store fx1, the store evaluation fx2, and the irrationality evaluation fx3, and when the store is stored in the recommendation history storage unit 111 (when the store is a target to be recommended), calculates the visit likelihood evaluation g(x). In the estimation processing, each learning mode on a previous day is used.

The learning processing of each learning model is suitably performed at an appropriate timing. The timing may be during a visit or may be at night on a day on which the user visits.

In the present disclosure, the recommendation system 100 performs processing that assumes a recommendation message by Push notification, but the present disclosure is not limited thereto. The present disclosure can also be applied to a medium such as web advertisement.

A model may be made in a form in which as an input of the visit likelihood evaluation g(x), the visit candidate store fx1 and the store evaluation fx2 are included in another function like the input information of the irrationality evaluation fx3, without creating a function regarding each of the visit candidate store fx1, the store evaluation fx2, the irrationality evaluation fx3, and the visit likelihood evaluation g(x). That is, a model may be made in a form in which the irrationality evaluation fx3 is derived from the visit candidate store fx1 and the store evaluation fx2, and the input information before applying the function of the irrationality evaluation fx3, without calculating the irrationality evaluation fx3. Similarly, instead of calculating the visit candidate store fx1, the store evaluation fx2, and the irrationality evaluation fx3, g(x) may be obtained from the input information without applying the function. In the present disclosure, the input information includes at least one of the store information, the visit history of the user, the user attribute, and the recommendation history.

In regard to a machine learning method (machine learning model) of the visit candidate store fx1, the store evaluation fx2, the irrationality evaluation fx3, and the visit likelihood evaluation g(x), a method other than the method disclosed above may be used. In regard to the calculation method of each evaluation, other methods may be used instead of the machine learning method.

The width of a target of the objective variable may be expanded like “visited on the day” in the objective variable of the visit likelihood evaluation g(x) to “visited within one week after the recommendation”.

When an unnecessary recommendation is desired to be reduced (the reliability of the user on the recommendation is desired to increase to increase the recommendation effect), a form may be made in which the visit likelihood evaluation g(x) is employed to determine not to perform recommendation transmission. That is, when the value of the recommendation evaluation using the visit likelihood evaluation g(x) is equal to or less than a prescribed value, the recommendation system 100 may not make a recommendation to the user and for the store.

In regard to the generation of the statistical user information, other learning models, and the like, the items may be narrowed down to items suitable for the purposes of the store evaluation fx2 and the irrationality evaluation fx3. For example, in regard the store evaluation fx2, each item may be sorted out by eliminating a need for a time-series system such as whether the user has consecutively visited or whether the user has visited many times recently.

When data is insufficient due to model creation of each user or the like, the following processing may be applied. For example, as a calculation function of the visit candidate store fx1, a visit candidate store fx1 of a pseudo user may be added in addition to an operation log of the user and the visit candidate store fx1 determined from the above-described disclosure. In this case, stores with a large value may be added in order using the value of the visit candidate store fx1 (the degree to which the user remembers) of the pseudo user.

In regard to the store evaluation fx2, a value obtained by calculating and averaging evaluation values from the store evaluations fx2 of the pseudo users may be set as the result of the store evaluation fx2 of the target user.

In regard to the irrationality evaluation fx3, a value obtained by calculating and averaging evaluation values from the irrationality evaluations fx3 of the pseudo users may be set as the irrationality evaluation fx3 of the target user. Data (consecutive visits to previous store, . . . , etc) of the target user may be input to the irrationality evaluation fx3 of each pseudo user.

It is assumed that this is the second visit of the target user to the store A. In this case, modeling is performed using data of a pseudo user. The pseudo user is narrowed down to a pseudo user with data on the second visit to the store A. For example, total data (including a store other than the store A) until the pseudo user visits the store A a second time) is used. Data at that time is used and a result calculated using current fx1/fx2/fx3 of the user is used as training data of the visit likelihood evaluation g(x) of the target user.

Next, a modification example of the store acquisition unit 101 will be described. In the above-described disclosure, the store acquisition unit 101 calculates the degree to which the user remembers, from the number of visits in the area and the store visits with respect to the number of visits, and obtains the visit candidate stores on the basis of the degree to which the user remembers.

In the modification example, the store acquisition unit 101 acquires a browsing history of the store information for each user in addition to or instead of the above-described information, and calculates a degree of familiarity (corresponding to a degree of confirmation of the store) of the store information on the basis of a browsing time and the number of times of browsing. A store having a high degree of familiarity is set as a visit candidate store.

In the modification example, the user can browse the store information through a web or other applications using a smartphone, a personal computer, or a tablet terminal.

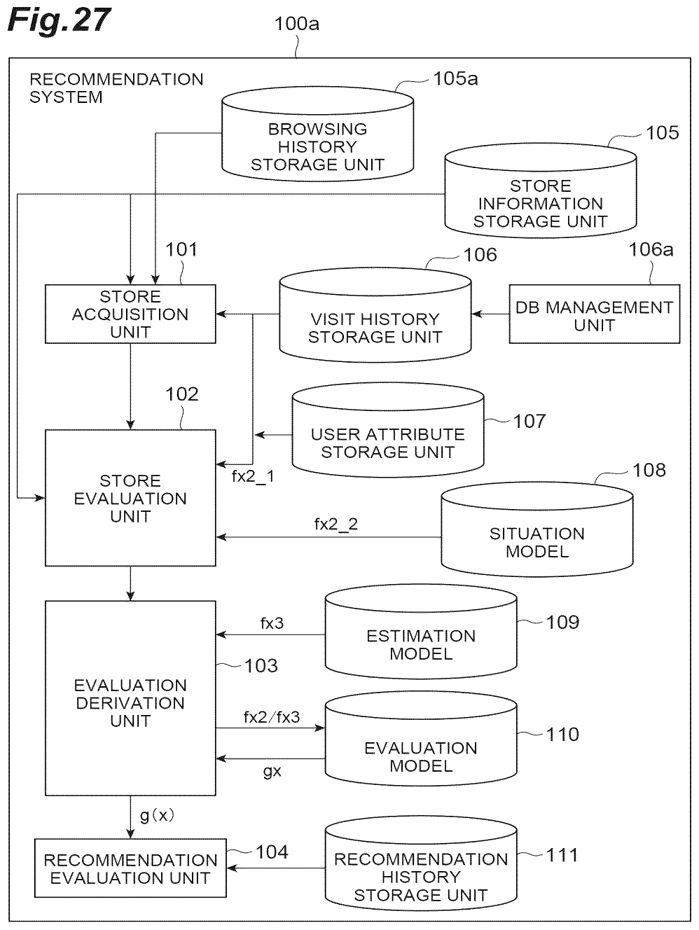

FIG. 27 is a block diagram illustrating a functional configuration of a recommendation system 100a in the modification example. As illustrated in the drawing, the recommendation system 100a in the modification example includes a browsing history storage unit 105a, in addition to the functional configuration of the recommendation system 100 of FIG. 3.

The store acquisition unit 101 acquires the visit candidate store fx1 with reference to the browsing history storage unit 105a.

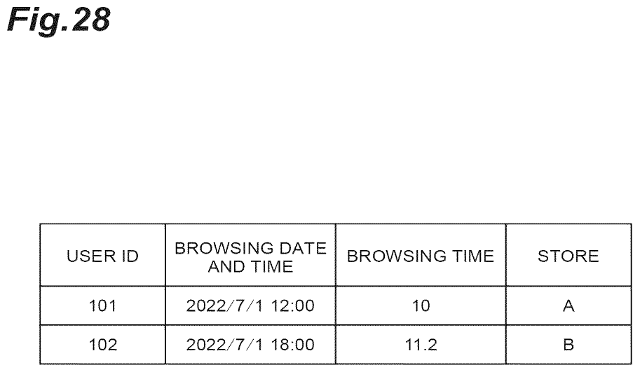

FIG. 28 is a diagram illustrating a specific example of the browsing history storage unit 105a. As illustrated in the drawing, a browsing date and time, a browsing time, and browsed store information are stored in association with each other for each user. Such information is acquired from the user terminal that has browsed the store information, but other methods may be used. For example, the recommendation system 100a may collect such information from the user terminal or a known Internet connection provider may provide such information to the recommendation system 100a.

In more detail, the store acquisition unit 101 calculates the degree of familiarity of each store on the basis of the browsing time and an elapsed time after browsing for each store. The following expression is an example of an equation for obtaining the degree of familiarity.

$$f ( store ) = \sum s * day \qquad [ Equation 2 ]$$

s: a browsing time (normalized by an average browsing time of the user)
day: a discount rate set in advance according to how many days ago the user has visited

The above-described day is set as a discount rate (coefficient) for discounting an evaluation value on the basis of the number of elapsed days after a visit. The coefficient is determined to become low according to the number of elapsed days. For example, the coefficient becomes ⅓ when three days have elapsed and 1/10 when ten days have elapsed.

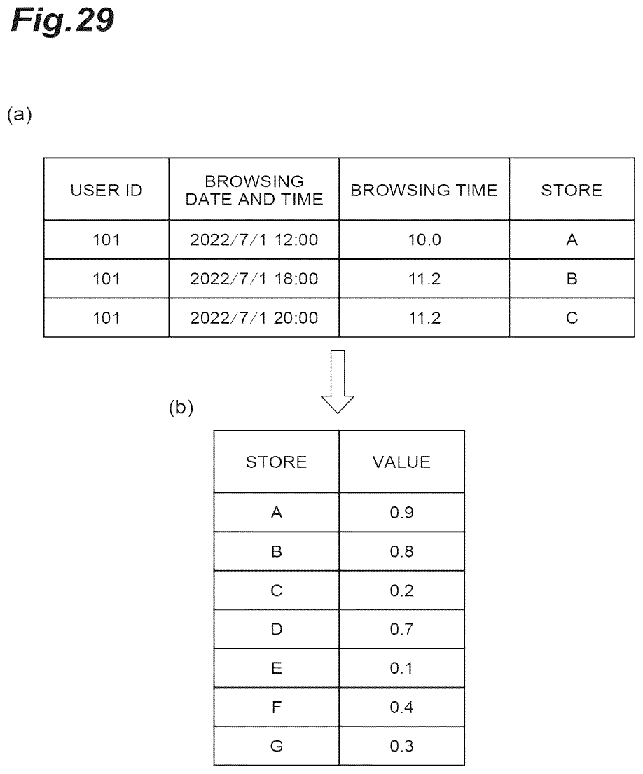

FIG. 29 is a schematic view when a value (degree of familiarity) of each store is calculated from browsing history information. FIG. 29(a) is a diagram illustrating the browsing history information, and FIG. 29(b) is a diagram illustrating the degree of familiarity of each store. FIG. 29(b) illustrates a result calculated on the basis of the above-described expression. Hereinafter, a value in a table indicates a degree of familiarity.

The store acquisition unit 101 acquires a visit candidate store fx1_1 to be presented to the user on the basis of the degree of familiarity. In addition, as described above (see FIG. 12), the store acquisition unit 101 may set a nearby store as a visit candidate store on the basis of browsing history information.

Another modification example is also considered. For example, the above-described example may be as follows.

$$f ( store A ) = \sum s * day * t * ( 1 - recom ) \qquad [ Equation 3 ]$$

s: a browsing time (normalized by an average browsing time of the user) day: a discount rate set in advance according to how many days ago the user has browsed
t: an amplification rate set in advance according to how many times the user has browsed
recom: whether the user has browsed based on a recommendation

This expression is made from an idea that the longer the browsing time and the more the number of visits, the higher the degree of familiarity. When the user browses a web or the like of the store with the reception of the recommendation according to the above-described disclosure, an expression is made such that the store is removed from a candidate. In the above-described expression, when the user has browsed based on the recommendation, recom=1, and otherwise, recom=0. In regard to t, an amplification rate is set according to the number of times of browsing. For example, if the number of times of browsing is three or more, 1.3 times is set. In regard to t, the amplification rate is set such that the more the number of times of browsing, the longer the browsing time. Since the more the number of times of browsing, the greater the amplification rate, the degree of familiarity is highly evaluated.

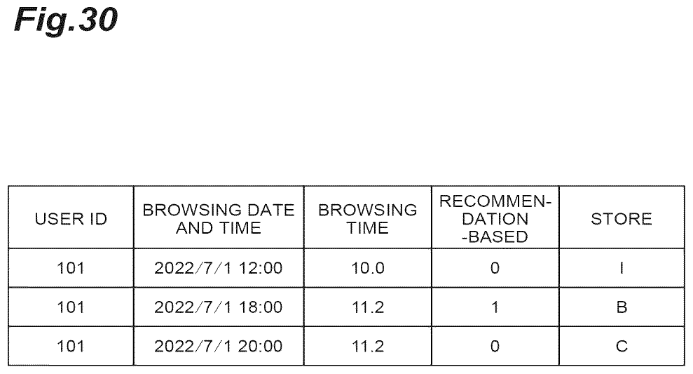

FIG. 30 is a diagram illustrating a specific example of the browsing history storage unit 105a that stores whether the user has browsed based on a recommendation. As illustrated in the drawing, information on whether the user has browsed based on a recommendation is further stored. Information on whether the user has browsed based on a recommendation is stored when the above-described recommendation system 100 sends a recommendation to the user terminal 200 and the recommendation system 100 determines that the user terminal 200 performs web browsing or the like based on the recommendation. The determination is made by processing of receiving notification that the user performs web browsing or the like within a prescribed time after receiving the recommendation from the user terminal 200. Alternatively, the recommendation system 100 may access the user terminal 200 regularly to transmit a recommendation, and may collect that the user terminal performs web browsing regarding the recommendation within a prescribed time.

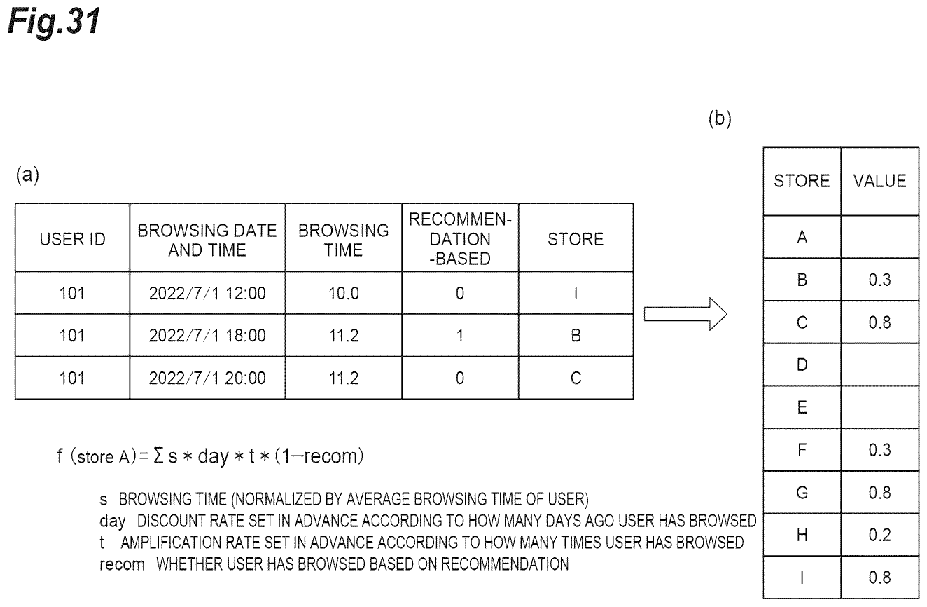

FIG. 31 is a schematic view when the degree of familiarity of each store is calculated from the browsing history information. FIG. 31(a) is a diagram illustrating the browsing history information, and FIG. 31(b) is a diagram illustrating the degree of familiarity of each store. FIG. 31(b) illustrates a result calculated on the basis of the above-described expression. Since the more the number of visits is, the shorter the browsing time becomes, the degree of familiarity may be amplified by an amount corresponding to the shortened browsing time. For example, in regard to a store with the number of visits equal to or greater than a prescribed number of times from the visit history in the visit history information, the value may be multiplied by a coefficient greater than 1.

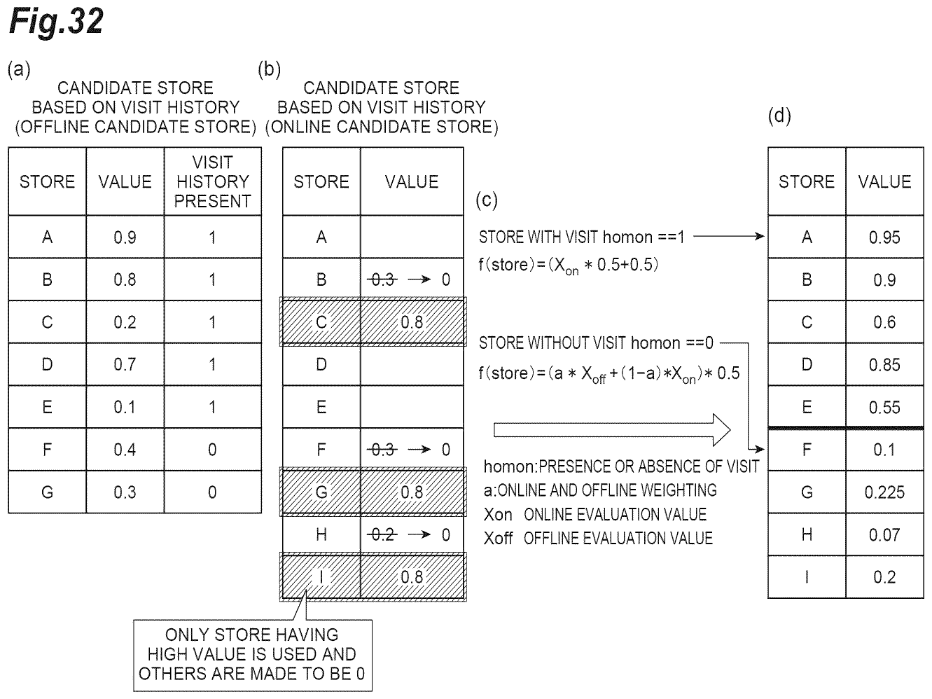

Processing taking into account both the visit history and the browsing history may be performed. The above-described store evaluation unit 102 may perform store evaluation on the visit candidate store fx1_1 obtained from the browsing history information, may perform store evaluation only on the visit candidate store fx1_1 obtained from the visit history information, or may perform store evaluation on both the visit candidate store fx1_1 obtained from the browsing history information and the visit candidate store fx1_1 obtained from the visit history information. The value (degree of familiarity) of the visit candidate store fx1_1 may be adjusted by weighting. FIG. 32 is a schematic view illustrating processing taking into account both the visit history and the browsing history.

FIG. 32(a) illustrates visit candidate stores obtained on the basis of the visit history stored in the visit history storage unit 106 and evaluation values thereof. Here, the presence or absence of the visit history is further associated. The presence or absence of the visit history is obtained on the basis of the visit history information (see FIG. 13(a)). FIG. 32(b) illustrates visit candidate stores based on the browsing history storage unit 105a and evaluation values thereof. Only stores having a high evaluation value are used, and other evaluation values are set to 0. A store having a low evaluation value may be regarded as a store of which the store information has been barely browsed.

The store acquisition unit 101 obtains the visit candidate store fx1 according to both the visit history and the browsing history using such information.

If online candidate store information and offline candidate store information are obtained, the store acquisition unit 101 obtains the evaluation value for each store using the following equation (FIG. 32(c)) in each of the online candidate store information and the offline candidate store information. According to this expression, a visited store and an unvisited store are separately evaluated. The visited store is highly evaluated.

$$store with visit homon == 1 \qquad [ Equation 4 ]$$

$$f ( store ) = ( Xon * 0.5 + 0.5 )$$

$$store without visit homon == 0$$

$$f ( store ) = ( a * Xoff + ( 1 - a ) Xon ) + 0.5$$

homon: the presence or absence of a visit
a: online and offline weighting
Xon: an online evaluation value
Xoff: an offline evaluation value

The online evaluation value is an evaluation value (degree of familiarity) based on the visit history, and the offline evaluation value is an evaluation value (degree of familiarity) based on the browsing history.

FIG. 32(d) illustrates a result. An evaluation value of a store with a visit history becomes 0, and in regard to a store without a visit history, an evaluation value is obtained. The store acquisition unit 101 can derive the visit candidate store fx1 on the basis of the evaluation value. In the above description, while a nearby store has been omitted for simplification of description, the visit candidate store fx1 may be of course derived taking into account the nearby store. For example, in regard to the nearby store, the evaluation value may be adjusted by multiplying the evaluation value by a prescribed coefficient.

Next, the operation and effects of the recommendation system 100 of the present disclosure will be described.

The recommendation system 100 of the present disclosure includes the evaluation derivation unit 103 configured to derive the visit likelihood evaluation g(x) for the store that has been recommended to the target user and the visit likelihood evaluation g(x) assuming that no recommended has been made, and the recommendation evaluation unit 104 configured to derive the recommendation evaluation on the basis of the visit likelihood evaluation g(x) for the store that has been recommended and the visit likelihood evaluation assuming that no recommendation has been made.

According to this disclosure, it is possible to appropriately perform recommendation evaluation. Therefore, it is possible to allow an operator of a recommendation to rationally obtain the fee of the recommendation.

In the recommendation system 100 of the present disclosure, the evaluation derivation unit 103 derives the visit likelihood evaluation g(x) on the basis of at least one of the attribute evaluation fx2_1 for the recommended store of the user, the constraint evaluation fx2_2 according to the visit situation of the user when the user has visited the recommended store, and the irrationality evaluation fx3 based on the last visit information of the user for the recommended store and other stores.

According to the present disclosure, it is possible to appropriately determine the visit likelihood of the user using such information.

In the recommendation system 100 of the present disclosure, the evaluation derivation unit 103 inputs at least one of the attribute evaluation fx2_1, the constraint evaluation fx2_2, and the irrationality evaluation fx3 using the evaluation model 110 trained by machine learning to derive the visit likelihood evaluation g(x).

Then, the evaluation model 110 is prepared for learning and is trained with at least one of the attribute evaluation fx2_1, the constraint evaluation fx2_2, and the irrationality evaluation fx3 indicating the last visit information for the stores (for example, the above-described visit candidate stores) based on the store that the user has visited, and the presence or absence of a recommendation as an explanatory variable and the presence or absence of a visit as an objective variable.

According to this disclosure, it is possible to appropriately calculate the visit likelihood evaluation g(x) using the evaluation model trained by machine learning. In the present disclosure, data used for learning is based on the visit candidate stores, but the present disclosure is not limited thereto, and data used for learning may be based on stores that the user does not visit, non-nearby stores, and the like.

The recommendation system 100 of the present disclosure further includes the store evaluation unit 102 configured to perform the store evaluation fx2 of the visit candidate store fx1 selected on the basis of the action (visit) of the user. The evaluation derivation unit 103 derives the visit likelihood evaluation g(x) on the basis of the store evaluation fx2 of the visit candidate store.

More specifically, the recommendation system 100 further includes the visit history storage unit 106 configured to store the visit history (date and time, store, transportation means, and the like) for each user, and the user attribute storage unit 107 configured to store the user attribute information (age, sex, and the like) for each user.

Then, the store evaluation unit 102 acquires, for each store, the attribute tendency (age, sex, and the like) of the user who has visited the store, from the visit history and the user attribute information. The attribute tendency indicates, for example, the above-described statistical user information, and is information indicating the tendency of the attribute of the user who has visited each store. Then, the store evaluation unit 102 derives the attribute evaluation fx2_1 of the target user for each candidate store on the basis of the user attribute of the target user and the attribute tendency of the target user.

According to this disclosure, it is possible to evaluate a store according to the interest and preference of the user.

The recommendation system 100 further includes the situation model 108. The situation model 108 is generated for each visit situation of the user on the basis of the visit history (transportation means, the presence or absence of a companion, time period, and the like) of the user. A plurality of situation models 108 are generated. The situation model 108 receives the visit situation of the user as an input and outputs the evaluation value for the store.

Then, the store evaluation unit 102 selects the situation model 108 corresponding to the visit situation of the user and derives the constraint evaluation fx2_2 for the store of the user from the situation model 108.

In the recommendation system 100, the situation model 108 links the store information of the visited store in the visit situation corresponding to the visit situation pattern sorted from the visit history of the user, and is trained by machine learning for each visit situation pattern with the store information prepared for each store as an explanatory variable and the visit situation pattern of each store as an objective variable.

For example, the situation model 108 is trained by the learning device 120. The learning device 120 is configured to access the store information storage unit 105 that stores the store information for each store. The learning device 120 includes the visit history storage unit 106 configured to store visit histories of all users, the visit situation pattern sorting unit 121 configured to perform sorting to the visit situation pattern from the visit history, and the learning unit 122 configured to link the visit situation pattern and the store information of the visited store in the visit situation corresponding to the visit situation pattern and learn the situation model 108 by machine learning for each visit situation pattern with the store information as an explanatory variable and the presence or absence of the visit in the visit situation pattern of each store as an objective variable.

As a result, it is possible to generate the situation model 108 for each visit situation pattern.

The recommendation system 100 further includes the estimation model 109 configured to receive the last visit information of each store as an input and output the irrationality evaluation fx3 for the store. The evaluation derivation unit 103 derives the visit likelihood evaluation g(x) using the estimation model 109.

The estimation model 109 is trained by the learning device 130 and generated. The learning device 130 includes the acquisition unit 131 configured to acquire, for each store, the last visit information including the visit frequency information (the number of repetitions, the number of elapsed days, the genre, and the like) of the user for the store and the last situation information (weather, the previous price range, . . . , the presence or absence of the visit of the store, and the like) of the user at that time from the visit candidate information (visit date and time, visit store, and candidate store at that time) of the user, and the learning unit 132 configured to learn the estimation model 109 with the last visit information of each store as an explanatory variable and the presence or absence of the visit of each store as an objective variable.

The evaluation derivation unit 103 derives the irrationality evaluation fx3 using the estimation model 109.

As a result, it is possible to learn the estimation model 109.

The recommendation system 100 of the present disclosure includes the visit history storage unit 106 configured to store the visit history (date and time, store, transportation means, and the like) for each user, and the store acquisition unit 101 that functions as a store derivation unit configured to derive, as the candidate store, the visited store or the nearby store near the store on the basis of the visit history. The evaluation derivation unit 103 derives an evaluation for the candidate store.

With this configuration, a store that the user has not visited can also be evaluated.

Next, the operation and effects when the recommendation system 100 of the present disclosure functions as a store derivation device will be described.

The recommendation system 100 that functions as the store derivation device of the present disclosure includes the visit history storage unit 106 configured to store visit history information of a store as an action history of a user. Further, the store acquisition unit 101 acquires a familiar store (degree of familiarity) of the user with respect to the store on the basis of the visit history information. The store acquisition unit 101 derives the visit candidate store fx1 that the user is recommended to visit, on the basis of the familiar store (degree of familiarity).

With this configuration, it is possible to derive the visit candidate store fx1 on the basis of the familiar store. Through recommendation processing using the visit candidate store fx1, it is possible to perform more effective recommendation compared to when a store (a store with which the user is not familiar or a store that the user does not remember much) according to the degree of familiarity is recommended.

The store acquisition unit 101 is configured to evaluate, for each store indicated in the visit history, the store on the basis of the number of visits (the number of actions) and the number of elapsed days after the action, and derive the visit candidate store fx1 on the basis of the evaluation. The evaluation is calculated such that the evaluation becomes lower as the number of elapsed days becomes greater.

It is considered that a degree to which a person remembers a store generally significantly affects the number of visits and the visit interval (in particular, the number of elapsed days after the last day) after the visit. According to the present disclosure, since the degree of remembering (degree of familiarity) is calculated on the basis of the number of visits and the number of elapsed days after the visit, it is possible to perform appropriate evaluation of a store as a visit candidate store.

The store acquisition unit 101 may be configured to derive the nearby store near the candidate store, to be included in the visit candidate store fx1. For this reason, the store acquisition unit 101 may be configured to set a value obtained by multiplying the evaluation of the visit candidate store by a prescribed coefficient as an evaluation of the nearby store and derive several stores among the nearby stores as a candidate store on the basis of the evaluation.

The nearby store near the store that the user has visited may be a store that the user has seen or remembers.

The store acquisition unit 101 performs derivation processing for a store in an area that the user has visited.

In the description of the operation and effects described above, while a visit of a user to a store has been described, a visit to a store may be interpreted as browsing of store information on a web. That is, the action of the user may include a visit to a store or browsing of store information.

In the present disclosure, when the action of the user is the browsing of the store information, the degree of familiarity with the store is calculated according to whether the browsing is browsing for a store that has been recommended to the user.

For example, when the store is recommended to the user in advance, since the user is familiar with the store, the degree of familiarity is set to be high. Otherwise, the degree of familiarity is adjusted to be 0.

In the present disclosure, the action of the user is a visit to a store and browsing of store information, and the degree of familiarity is calculated on the basis of the visit to the store and the browsing of the store information.

For example, a total degree of familiarity is calculated by appropriately weighting the degree of familiarity based on the visit and the degree of familiarity based on the browsing.

In this case, the degree of familiarity is calculated such that a value is greater for a store that the user has visited. The degree of familiarity is calculated on the basis of a value based on the browsing of the store information equal to or greater than a prescribed value. When the degree of familiarity is low, this is treated as synonymous with that the user not having visited the store.

The recommendation evaluation device, which is the recommendation system 100 of the present invention, has the following configuration.

[1]

A store derivation device comprising:
a visit history storage unit configured to store an action history of a user;
a calculation unit configured to calculate a degree of familiarity of the user with a store on the basis of the action history; and
a store derivation unit configured to derive a candidate store that the user is recommended to visit, on the basis of the degree of familiarity.
   [2]

The store derivation device according to [1],
wherein the calculation unit is configured to
calculate a degree of familiarity on the basis of the number of actions and the number of elapsed days after an action for each store indicated in the visit history, and
derive the candidate store on the basis of the degree of familiarity.
   [3]

The store derivation device according to [2],
wherein the degree of familiarity is calculated such that an evaluation becomes lower as the number of elapsed days becomes greater.
   [4]

The store derivation device according to any one of [1] to [3],
wherein the store derivation unit is configured to derive a nearby store near the candidate store as a candidate store.
   [5]

The store derivation device according to [4],
wherein the store derivation unit is configured to set a value obtained by multiplying the degree of familiarity with the candidate store by a prescribed coefficient as a degree of familiarity with the nearby store and derive several stores among nearby stores as a candidate store on the basis of the degree of familiarity.
   [6]

The store derivation device according to any one of [1] to [5],
wherein the action of the user is a visit to a store or browsing of store information.
   [7]

The store derivation device according to any one of [1] to [6],
wherein, when the action of the user is browsing of store information,
the degree of familiarity with the store is calculated according to whether the browsing is browsing for a store that has been recommended to the user.
   [8]

The store derivation device according to any one of [1] to [7],
wherein the action of the user is a visit to a store and browsing of store information, and
the degree of familiarity is calculated on the basis of the visit to the store and the browsing of the store information.
   [9]

The store derivation device according to [8],
wherein the degree of familiarity is calculated such that a value is greater for a store that user has visited.
   [10]

The store derivation device according to [8] or [9],
wherein the degree of familiarity is calculated on the basis of a value based on the browsing of the store information equal to or greater than a prescribed value.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

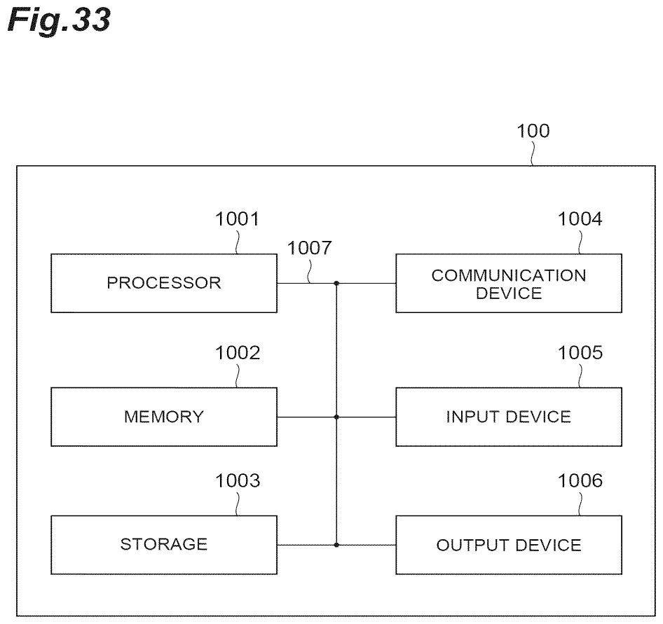

For example, the recommendation system 100 and the like according to one embodiment of the present disclosure may function as a computer that performs processing of a recommendation method or a conversation information generation method according to the present disclosure. FIG. 33 is a view showing an example of the hardware configuration of the recommendation system 100 according to one embodiment of the present disclosure. The recommendation system 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the recommendation system 100 may be configured to include one or a plurality of the devices shown in the drawings or may be configured without including some of those devices.

The functions of the recommendation system 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the store acquisition unit 101, the store evaluation unit 102, the evaluation derivation unit 103, and the recommendation evaluation unit 104 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, store acquisition unit 101 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing a recommendation evaluation method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, one function of the above-described store acquisition unit 101 may be implemented by the communication device 1004. The communication device 1004 may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the recommendation system 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100 Recommendation system, 200 User terminal, 300 Store, 101 Store acquisition unit, 102 Store evaluation unit, 103 Evaluation derivation unit, 104 Recommendation evaluation unit, 105 Store information storage unit, 106 Visit history storage unit, 106a DB management unit, 107 User attribute storage unit, 108 Situation model, 109 Estimation model, 110 Evaluation model, 111 Recommendation history storage unit.

1. A store derivation device comprising:
a visit history storage unit configured to store an action history of a user;
a calculation unit configured to calculate a degree of familiarity of the user with a store on the basis of the action history; and
a store derivation unit configured to derive a candidate store that the user is recommended to visit, on the basis of the degree of familiarity.

2. The store derivation device according to claim 1,
wherein the calculation unit is configured to
calculate a degree of familiarity on the basis of the number of actions and the number of elapsed days after an action for each store indicated in the visit history, and
derive the candidate store on the basis of the degree of familiarity.

3. The store derivation device according to claim 2,
wherein the degree of familiarity is calculated such that an evaluation becomes lower as the number of elapsed days becomes greater.

4. The store derivation device according to claim 1,
wherein the store derivation unit is configured to derive a nearby store near the candidate store as a candidate store.

5. The store derivation device according to claim 4,
wherein the store derivation unit is configured to set a value obtained by multiplying the degree of familiarity with the candidate store by a prescribed coefficient as a degree of familiarity with the nearby store and derive several stores among nearby stores as a candidate store on the basis of the degree of familiarity.

6. The store derivation device according to claim 1,
wherein the action of the user is a visit to a store or browsing of store information.

7. The store derivation device according to claim 1,
wherein, when the action of the user is browsing of store information,
the degree of familiarity with the store is calculated according to whether the browsing is browsing for a store that has been recommended to the user.

8. The store derivation device according to claim 1,
wherein the action of the user is a visit to a store and browsing of store information, and
the degree of familiarity is calculated on the basis of the visit to the store and the browsing of the store information.

9. The store derivation device according to claim 8,
wherein the degree of familiarity is calculated such that a value is greater for a store that user has visited.

10. The store derivation device according to claim 8,
wherein the degree of familiarity is calculated on the basis of a value based on the browsing of the store information equal to or greater than a prescribed value.
